(19) United States
(12) Patent Application Publication
(10) Pub. No.: US 2005/0003827 A1
(43) Pub. Date: Jan. 6, 2005

(54) Channel, coding and power management for wireless local area networks

(76) Inventor: Robert J. Whelan, Kirkland, WA (US)

Correspondence Address: JONES DAY, 222 EAST 41ST ST, NEW YORK, NY, 10017, US

(21) Appl. No.: 10/778,758

(22) Filed: Feb. 13, 2004

Related U.S. Application Data
(60) Provisional application No. 60/447,166, filed on Feb. 13, 2003.

(51) Int. Cl. H04Q 7/20

(52) U.S. Cl. 455/454

(57) ABSTRACT

A system and method are disclosed for the management of WLANs in cases where unmanaged access points are present as well as with the addition or removal of access points. The disclosed system and method use signal data and network traffic statistics collected by mobile units to determine optimal configuration settings for the access points. The access point settings so managed can include the operating channel or center frequency, orthogonal signal coding used (optionally including the data rate), if any, and the transmission power. The solutions computed can account for the inherent trade-offs between wireless network coverage area and mutual interference that may arises when two or more access points use the same or overlapping frequency bands or channels and the same or similar signal coding.

### FIELD OF THE INVENTION

This application relates to the field of Wireless Local Area Network (WLAN) network management.

### BACKGROUND

In a WLAN, one or more base stations or access points (AP) bridge between a wired network and radio frequency or infrared connections to one or more mobile stations or Mobile Units (MU). The MUs can be any of a wide variety of devices including, laptop computers, personal digital assistants, wireless bar code scanners, wireless point of sale systems or payment terminals, and many other specialized devices. Most WLAN systems used in business and public access environments adhere to the IEEE 802.11 specifications. Other WLANS are based on other wireless technologies including, the specifications promulgated by the Bluetooth Special Interest Group, proprietary radio frequency protocols and infrared-link protocols.

Wireless Local Area Networks (WLANs) are now in common use in both large and small businesses, as public Internet access points, and in home environments. Millions of base-stations or access points and mobile units are now deployed. Access points and base stations are understood here to include implementations with more than one central frequencies and more than one antennas. This increasing density of access points creates additional network management problems. Specifically access points using the same or overlapping frequency bands or channels and the same or similar signal coding have the potential to create mutual interference. Mutual interference leads to packet collisions, the need to retransmit packets, potentially reducing network throughput. At the same time, the coverage area of the access points may not be sufficient, leading to poor signal quality at the edges of the network or “coverage holes”.

Conventional approaches to the optimization of wireless networks involve making surveys of the desired coverage area. The results of these surveys are then used to determine the optimum settings for channel selection, signal coding and power for the access points.

Attempts may also be made to determine if existing access points should be moved to other locations or new access points added to the wireless network. Survey approaches suffer from several difficulties including:

1. It is usually quite expensive to collect and analyze the data.

2. The survey data is static. Thus, if conditions change within the area of interest the survey would need to be run once again or the design of the wireless network would be less than optimal.

3. The equipment used to make the survey typically has fixed and distinctive physical properties (antennas, receivers, velocity of travel, etc.). In practice, mobile units will have different physical properties and will therefore experience wireless network quality that is different from the survey equipment.

Other approaches to management of wireless networks can involve the collection of signal measurements by access points. In these schemes, the wireless network management system uses signal information collected by the access points as a basis to adjust the channel assignments, signal coding assignments and power levels, in attempts to optimize network performance. In most cases the access points collect information on the signals broadcast by the other access points. These schemes suffer from a number of drawbacks including:
1. The access points can only take measurements at fixed locations;
2. The receiver and antenna properties of the access point can be quite different from those of the mobile units;
3. The transmission power levels of the access points and mobile units may be quite different; and,
4. The possible use of diversity antennas in access points, but not in mobile units.
5. Each single access point only has local knowledge of the environment and is thus, unlikely to make changes that are globally optimal.

### SUMMARY

The channel, coding and power management system described overcomes the deficiencies of prior art power, coding and channel management systems through a simplified approach using data collected from mobile units to optimize the performance of the network. The system provides for the management of WLANs in cases where unmanaged access points are present. Further, the system can provide information on the possible need to add access points.

The disclosed channel, coding and power management system uses signal data and network traffic statistics collected by the mobile units to determine optimal configuration settings for the access points. The access point settings managed by the system can include the operating channel or center frequency, orthogonal signal coding used, if any, and the transmission power. In some embodiments, signal coding can include the data rate used by the mobile units and the access points, which may also be controlled. The solutions computed can account for the inherent trade-offs between wireless network coverage area and mutual interference. Mutual interference arises when two or more access points use the same or overlapping frequency bands or channels and the same or similar signal coding. These situations can arise as a result of the often-limited choice available of channels and orthogonal codes. Higher levels of mutual interference can lead to low network data throughput. On the other hand, reasonable access point transmission power must be maintained to achieve coverage of the desired areas.

Any device can perform the collection and reporting of radio frequency signal data if it has the required receiver, signal measurement capabilities and any type of data connection to data repository. In the following discussion, these devices will be referred to has “mobile units”, but can in fact include a number of other types of devices including:

1. The device may be any type of general-purpose computer, for which the main purpose is not to collect data, but rather collects data and reports in available idle time.

2. The device used for data collection may not require any special purpose hardware or driver software, but may only use standard configurations.

3. The device may or may not move with time.

4. The device may be dedicated to the collection of radio signal data at a fixed location or moving between several locations with time.

5. May have one or more additional network interfaces, some of which may connect to wired networks or other wireless networks.

The computations of the channel, coding, and power management system can determine neighbor relationships between access points without the need for geographic location data. In some embodiments, the system uses signal strength relationships between access points to determine the relative distances. These distances are then used to determine neighbor relationships between the access points. These neighbor relationships are, thus, based on radio frequency propagation or path loss relations, and may more accurately define the coverage areas of the access points and the potential for mutual interference when compared to the geometric relationships of geographically defined models. In some alternative embodiments, geographic location of the access points can be used to determine neighbor relationships. In yet other alternative embodiments, geographic location of the access points, along with signal strength measurements from the mobile units, can be used to determine neighbor relationships.

In some embodiments, the mobile units will experience signal interference from unmanaged access points or other sources of in-band radio frequency energy. The access point settings determined by the system can account for these sources. Typically, signal strength information and neighbor relationships are used in these computations.

The same data collected by the mobile units can be used to report on and possibly respond to the state of network performance. System administrators use the system's reporting capabilities to determine if the network is operating properly, to review automatically computed access point setting changes, and if required perform manual settings. Thus, the system can accommodate a mixture of automatic and manual control and reporting techniques.

Signal data and traffic statistics collected by the mobile units can be subject to considerable variation or fluctuations. These variations or fluctuations arise from a number of sources, including multi-path signal propagation, variations in mobile unit characteristics, time dependant changes in the network environment, and different travel paths used by the different mobile units. The limited dynamic range and noise characteristics of the mobile unit receivers can also contribute to fluctuations or variations in signal measurements. Additional variation can arise for the use of different access point characteristics and transmission power levels. In some embodiments, the data collected by the mobile units is preprocessed by a number of techniques, including censoring, combining, and power correction.

In some embodiments, the rate at which access point settings are updated can be adjusted. These time-dependent parameters allow the system to compute stable solutions, based on the long-term behavior of the network. If these time constants are too short, the settings may change in response to inconsequential changes in network measurements (i.e. variations in traffic volume), which can lead to unstable behavior or oscillations. If these time constants are too long, the access point settings may not change rapidly enough to respond effectively to changes in the network environment. Some embodiments incorporate parameters controlling the rate of changes in access point settings when a known change has been made to the network. Examples of known changes to the network include, the failure of an access point, the addition of a managed access point, and the removal of a managed access point.

In some embodiments, the channel, code and power management system can control the operation of redundant access points. If redundant access points are maintained in an online state, the result can be increased mutual interference and reduced network throughput as a result of having multiple access points with redundant coverage areas using a limited set of channels and orthogonal signal codes. To overcome these difficulties, but still allow for redundancy and high-availability, some embodiments of the power, channel and code management system include the capabilities to manage redundant access points in an offline configuration and only bring them online when required.

Depending on the details of the embodiment, the channel, code and power management system can apply to a variety of (often approximate) solution algorithms to the computation of optimal access point settings. A given solution technique can attempt to find the local (with respect to neighbors) solution for an access point's channel, signal coding and power settings. In other cases the solution can determine a globally optimum solution. In some embodiments an iterative or stepwise solution considering the local neighborhood for a given access point is applied. In other embodiments these solution iterative techniques are used to compute globally optimized solutions. Some other alternative embodiments can apply linear or nonlinear optimization techniques to the computation of a solution. In yet other alternative embodiments, evolutionary solution techniques can be used to compute local, or global solutions.

It will be appreciated that the foregoing statements of the features of the invention are not intended as exhaustive or limiting, the proper scope thereof being appreciated by reference to this entire disclosure and to the substance of the claims.

It will be understood that while the discussions contained in this document refer specifically to local area wireless networks with fixed base stations, it will be understood that the ideas discussed are equally applicable to wide area wireless networks and peer-to-peer wireless networks without fixed access points or base stations.

### BRIEF DESCRIPTION OF FIGURES

The invention will be described by reference to the preferred and alternative embodiments thereof in conjunction with the drawings in which:

FIG. 1 is a simplified diagram showing signal strength measurements by mobile units;

FIG. 2 is a hypothetical bit error rate curve for a mobile unit receiver;

FIG. 3 is an example of network throughput versus submitted data;

FIG. 4 is a simplified overall system block diagram;

FIGS. 5A, 5B, and 5C is a simplified diagram of a technique to determine propagation distance between access points;

FIGS. 6A, 6B, and 6C is a diagram showing a simplified example of access point configuration;

FIG. 7A, 7B, 7C, 7D, 7E, 7F, 7G and 7H is a simplified process flow diagram;

FIG. 8 is an example of access point coverage with mutual interference;

FIG. 9 is an example of access point coverage with reduced mutual interference;

FIG. 10 is an example of access point coverage with mutual interference;

FIG. 11 is an example of access point coverage with reduced mutual interference;

FIG. 12 is an example of access point coverage with a hole;

FIG. 13 is an example of expanded access point coverage;

FIG. 14 is an example of access point coverage with a new access point;

FIG. 15 is an example of access point coverage with an offline access point;

FIG. 16 is an example of access point coverage with increased power;

FIG. 17 is an example of access point coverage with overlap; and,

FIG. 18 illustrates an example of an access point configuration with redundancy.

### DETAILED DESCRIPTION OF EMBODIMENTS

The following detailed description refers to the accompanying drawings, and describes exemplary embodiments of the present invention. Other embodiments are possible and modifications may be made to the exemplary embodiments without departing from the spirit, functionality and scope of the invention. Therefore, the following detailed descriptions are not meant to limit the invention.

Overview of the Embodiments

To maximize performance and throughput of wireless networks, the mutual interference from the base-stations or access points experienced by the mobile units must be minimized.

Mutual interference arises when two or more access points use the same or overlapping frequency bands or channels and the same or similar signal coding. While it is desirable to reduce mutual interference, at the same time, the coverage area of the wireless network must be maintained. Thus, the selection of channels, the selection of signal coding and the setting of power levels for the access points must balance the competing desires to maximize coverage area while minimizing mutual interference.

The maximization of coverage area and minimization of mutual interference is made more complicated by both the complex real-world propagation environment and the fact that different mobile units have differing receiver and antenna characteristics. Thus, a wireless network optimized for one type of mobile unit applied to a particular range of applications may not optimal for another type of mobile unit applied to another range of applications. A wide range of factors can affect how a given mobile unit experiences the quality of a wireless network including:
1. The type of antenna or antennas used;
2. Velocity of travel and hence signal fading environment;
3. The possible use of antenna diversity techniques;
4. Polarization of antennas;
5. The types of modulation and signal coding; and,
6. The presence or absence of wave scattering and obstructing objects giving rise to signal shadowing and multi-path propagation.

Another complicating factor is the presence of unmanaged access points or other sources of radio frequency energy. An unmanaged access point can be any access point in or near the coverage area of interest. These unmanaged access points and sources of radio frequency energy can include:
1. Access points that belong to the organization managing the wireless network, but lacking the properties required to control any one or all of power, channel selection, and coding;
2. Access points under the control of other organizations but in the general area of the wireless network being managed;
3. Other radio services sharing the same spectrum, including remote control devices, cordless telephones, and data devices using other communications protocols and standards (e.g., Bluetooth vs. IEEE 802.11 standards); and,
4. Other sources of broadband interference including, electric motors and other electrical equipment, and electronic devices.

The complex environment affecting the quality of the wireless network is further complicated by the fact that the environment and even the properties of the mobile units themselves can dynamically change in time. It is not unusual for the physical environment to change. For example, construction can add or remove obstacles or objects scattering and shadowing signals. Managed access points may be moved over time for any number of reasons. The presence, absence, location or characteristics of unmanaged access points or other sources of radio frequency energy can change over time, sometimes at a rapid rate. Finally, new types of mobile units are introduced, which may have different physical properties or may be applied in new applications and will therefore experience the wireless network environment differently.

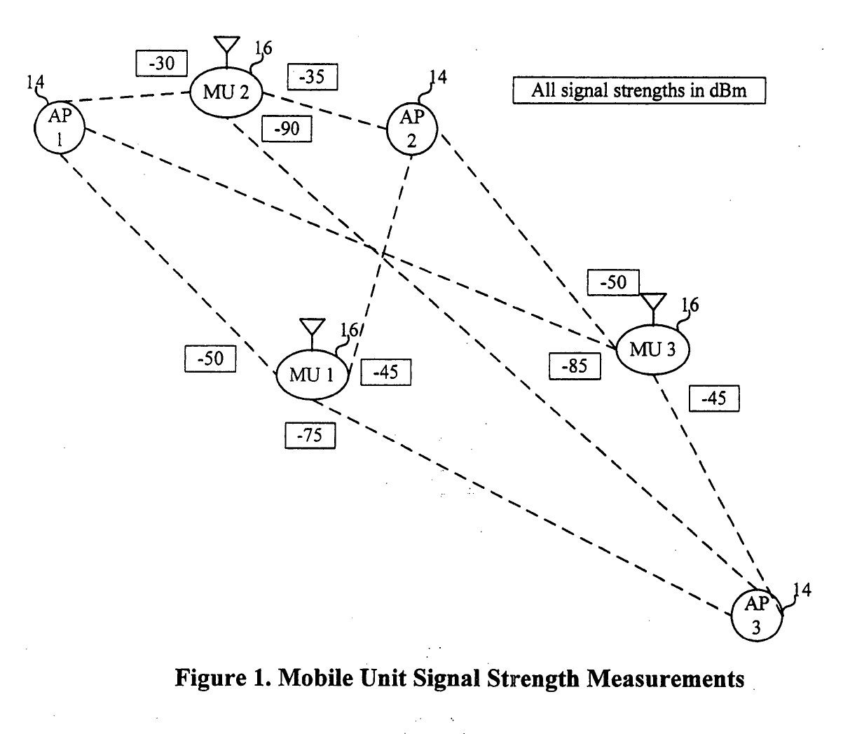

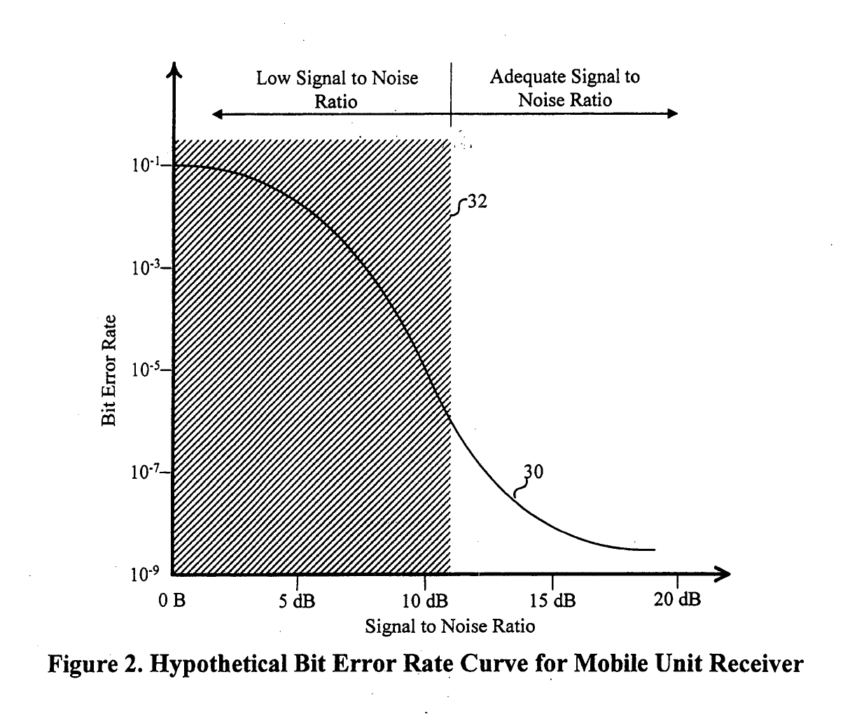

FIG. 1 shows a simplified diagram of signal strength measurements, i.e., Received Signal Strength Indicator (RSSI), experienced by mobile units. The access points 14 broadcast signals to the mobile units 16. The mobile units receive signals from one more access points. In this example the strength of the RSSI measured by the mobile unit from each access point is shown by a number in the box next to the dotted line connecting the mobile unit to that access point. In the example shown in FIG. 1, mobile unit MU2 receives relatively strong signals from access points AP1 and AP2, and receives a weaker signal from AP3. Depending on the channels and signal coding used by the mobile unit MU2, it may experience more or less mutual interference between these access points. Likewise mobile unit MU1 and MU3 receive signals at different strengths from the three access points.

FIG. 2 shows an example of the Bit Error Rate (BER) performance of a wireless receiver versus the Signal to Noise Ratio (SNR). The performance curve 30 shows the expected BER of the receiver over a range of SNR. If the SNR is too low 32, the BER of the receiver may become too high for the application. Therefore, it is usually advantageous to design the wireless network so that the SNR is sufficient to achieve adequate BER performance in the areas where the mobile units 16 operate. It will be understood that the desired range of BER and the SNR required to achieve this range is dependent on a number of factors including, the physical properties of the mobile unit, the type of signal modulation used, signal coding techniques applied, the transmission bit rate used and the applications communicating over the wireless link. Certain signal coding techniques allow a mobile unit to effectively operate in the presence of interfering signals. These techniques involve the use of multiple orthogonal codes. In effect, these coding techniques provide another dimension within which signals can be separated by a receiver. A wide variety of well known and emerging orthogonal coding techniques are applied in wireless local area networks, individually or in combinations, including:
1. Direct Sequence Spread Spectrum (DSSS) coding, which adds a high rate chip stream, chosen from a several possible orthogonal pseudorandom codes, to the bit stream, thereby adding resistance to errors during the decoding process; and,
2. Frequency Hopping Spread Spectrum (FHSS) techniques, where transmission frequencies are selected from several possible orthogonal pseudo random sequences to minimize the impact of interference at particular frequencies.

An additional signal coding variable can be the bit rate of transmissions used between the access points 14 and the mobile units 16. Transmissions at lower bit rates will achieve lower bit error rates for a given signal to noise ratio, when compared to higher bit rates (and assuming the signal coding and other variables are identical in both cases). In other words, a lower bit rate results in a higher energy per bit (or symbol). In-effect, as the bit rate is decreased the bit error rate curve 30 in FIG. 2 is shifted downward (to lower bit error rate at a given signal to noise ratio). As the bit rate is increased the bit error rate curve is shifted upward (higher bit error rate at a given signal to noise ratio).

The signal to noise ratio experienced by mobile units 16 depends on a wide variety of environmental factors including:
1. The signal level received at the mobile unit 16 from the access point 14;
2. Mutual interference from other access point 14 signals, using overlapping frequency bands and similar signal coding, received by the mobile units 16;
3. The multi-path signal environment experienced by the mobile unit 16;
4. Thermal or other electronic noise generated by the receiver of the mobile unit 16; and,
5. Other sources of electronic noise in the environment, including other wireless services using the same frequency bands and electronic or electrical equipment in the area.

As an example, if the mobile unit 16 MU 1, shown in FIG. 1, receives two packets transmitted, in overlapping time periods on the same channel, bit rate, and using the same signal coding, from two access points 14, AP 1 and AP 2, the signal to noise ratio will be only 5 dB (−45 dbm-(−50 dBm)). Referring to the example of FIG. 2, a signal to noise ratio of only 5 dB is likely to result in a bit error rate of approximately 10⁻¹, making accurate reception of either packet unlikely. On the other hand, if MU 1 receives two packets transmitted, in overlapping time periods on the same channel, bit rate, and using the same coding, from access points AP 1 and AP 3, the signal to noise ratio will be 25 dB (−50 dbm-(−75 dBm)). This signal to noise ratio should be more than sufficient to accurately receive the packet transmitted by AP 1, according to the bit error rate curve 30 shown in FIG. 2. Similar calculations and considerations can be applied to the other mobile units shown (MU 2 and MU 3).

Overview of Wireless Network Performance

Performance optimization for a wireless network involves a tradeoff between geographic coverage and throughput. Adding more access points to a network can improve coverage, but can lead to greater mutual interference and therefore less data throughput. The greater the level of mutual interference, the greater the chance of a packet not being received correctly, and therefore requiring retransmission. The increased retransmission or retry rate leads to lower total network data throughput. Further, complicating this coverage and mutual interference trade-off is the possible presence of nearby access points that are foreign to the network and are therefore not under network management control, or other sources of radio frequency interference.

The trade-offs between coverage and mutual interference can be formulated mathematically in a number or ways. The following analysis assumes that access points have fixed physical configurations (location, antenna configuration, electronic configuration, etc.). A coverage area of interest is defined over which to perform the analysis. Coverage areas can include a room in a building, a portion of a building, a floor of a building, an entire building, a campus of buildings, or a larger region. Access point parameters under management of network administrators typically include the transmission power, the choice of transmission center channel (or transmission frequency band), and the orthogonal signal coding applied to transmitted signals. In addition, the transmission bit rate used by the mobile units and access points may be under the control of the system. In this discussion it is assumed that different orthogonal signal codes can be used to separate signals in a code space, just as the use of different channels separates signals in frequency space. In most practical situations the choices of channels and signal codes that can be employed are limited to a relatively few choices. The objective is to optimize network performance by adjusting these managed parameters. In some cases, the key elements of the trade-off, as experienced by a mobile unit, can be formulated as follows:

```
(1) MAX {. C(area, bit rate, power)+
    - λ₁ 1(area, throughput, channel, bit rate, code, power) +
    - λ₂ U(area, throughput, channel, bit rate, code, power) }
```

Referring to Equation 1; the goal is to maximize (MAX) the performance characteristics of the network. The elements of this formulation can be explained as follows:

1. The coverage of the network (C(area, bit rate, power)) is a function of the area of interest (area), the transmission bit rate used, and the transmission power of the access points (power). In simplified terms, the higher the transmission power of the access points, the greater the signal strength and therefore the coverage area of the network. Lower transmission bit rates between the access points 14 and mobile units 16 can increase the effective coverage area, whereas using higher bit rates will decrease the effective coverage area. Choice of channel or signal coding has little effect on coverage area.

2. The mutual interference between the signals transmitted by managed the access points (I(area, throughput, channel, code, power)) is a function of the area of interest (area), the access point throughput or traffic level, the channels used by the access points (channel), the signal coding used by the access points (code), and the transmission power of the access points (power). In simplified terms, the higher the transmission power of the access points the greater the likelihood of mutual interference between the transmitted signals transmitted from the access points. This effect is in opposition to the greater cover area achieved by use of higher transmission power. The use of different channels or orthogonal codes separates signals in frequency or code space and therefore reduces mutual interference, regardless of the transmission power applied. The access point throughput determines the rate of packet transmission, which determines the probability of packet collisions or mutual interference. The transmission bit rate can change the effect of the interfering signal. An interfering signal with the same bit rate as the desired signal is more likely to cause interference than one with a higher bit rate (and likely corresponding higher bandwidth).

3. The mutual interference between the signals transmitted by managed access points and unmanaged access points (U(area, throughput, channel, code, bit rate, power)) is a function of the area of interest (area), the access point throughput or traffic level (throughput), the channels used by the access points (channel), the signal coding used by the access points (code), and the transmission power of the access points (power). It should be noted that the radio frequency propagation components of this function would be the same regardless if the access point is managed or unmanaged. In simplified terms, the higher the transmission power of the managed access points the greater the likelihood that signals transmitted from these managed access points the greater the likelihood that signals transmitted from these managed access points will be able overcome the mutual interference created by signals transmitted by the unmanaged access points. The stronger signals resulting from the greater transmission power from the managed access points will more likely overcome the signals transmitted by the unmanaged access points, increasing coverage area of the managed access points, but at the same time the likelihood of mutual interference between the signals from the managed access points is increased. The use of different channels or orthogonal codes separates signals in frequency or code space and therefore reduces mutual interference, regardless of the transmission power applied. It should be noted that the effects of other sources of radio frequency interference can be included in this term. The treatment is similar to that for unmanaged access points, but there may be no knowledge of the choice of parameters (power, channel, code). The access point throughput determines the rate of packet transmission, which determines the probability of packet collisions or mutual interference. The transmission bit rate can change the effect of the interfering signal. An interfering signal with the same bit rate as the desired signal is more likely to cause interference than one with a higher bit rate (and likely corresponding higher bandwidth).

4. The parameters λ₁ and λ₂ determine the tradeoff between network coverage and mutual interference. The parameter λ₁ determines the weight given to mutual interference generated by the managed access points while the parameter λ₂ determines the weight given to mutual interference with unmanaged access points. If λ₁ is decreased the optimal solution to Equation 1 is biased toward greater coverage and tolerating increased mutual interference between the managed access points. If λ₁ is increased the optimal solution to Equation 1 is biased toward less mutual interference. If λ₂ is increased the solution will be weighted toward overcoming mutual interference created by unmanaged access points. Decreasing λ₂ will have the opposite effect. Using different values λ₁ and λ₂ allows control of the weight given to mutual interference with managed and unmanaged access points to be determined independently. In some embodiments, the parameters λ₁ and λ₂ will be the same, which case the effects of mutual interference from managed access points will be weighted the same as mutual interference from unmanaged access points

It should be understood that there is no single best setting for the trade-off between network coverage and throughput. In some cases, the need to provide reliable network coverage over an area of interest may outweigh the desire to limit mutual interference to maintain data throughput. In other cases, data throughput for critical applications may be deemed critical and some network coverage may need to be sacrificed to obtain the desired performance. In any case, some judgment, and perhaps experimentation, will typically be applied when determining the best settings for any particular situation.

One Formulation

In some cases, the optimization of the wireless network can be formulated using an equation. It should be understood that other formulations are possible. Further, any formulation is likely to be useful to understand the structure of the problem, rather than a set of well defined equations, which can be solved directly. One example of a formulation of the wireless network optimization problem can be written as:

$$MAX {\sum }_{i = 1 , n}^{} \{ {\sum }_{i = 1 , n}^{} \int \int {g}_{i , j} ( {power}_{j} , {rate}_{i} ) ⅆ A - {λ}_{1} {\sum }_{j = 1 , m}^{} {\sum }_{k = 1 , m}^{} P ( {t}_{j} , {t}_{k} ) \int \int {f}_{i , jk} ( {channel}_{j} , {code}_{i} , {rate}_{j} , {power}_{j} , {channel}_{k} , {code}_{k} , {rate}_{k} , {power}_{k} ) ⅆ A + {λ}_{2} {\sum }_{j = 1 , m}^{} {\sum }_{1 = 1 , p}^{} P ( {t}_{j} , {t}_{p} ) \int \int {f}_{i , j , p} ( {channel}_{j} , {code}_{j} , {rate}_{j} , {power}_{j} , {channel}_{p} , {code}_{p} , {rate}_{p} , {power}_{p} ) ⅆ A ] \} \qquad ( 2 )$$

Referring to Function 2:

The summation index i is over the n mobile units 16 experiencing the quality of the wireless network, and thus accounts for the performance experienced by multiple mobile units. The summation index j and index k are over the m managed access points 14.

The function gᵢⱼ(rateⱼ, powerⱼ) represents the signal quality experienced by the mobile unit i from the access point m, broadcasting at a data rate rateⱼ with a particular power level: powerⱼ. in the absence of mutual interference. The function g_{i,j} is represents several factors including, the physical properties of the access point (antenna configuration, etc.) the propagation conditions over the one or more paths from the access point to the mobile unit and the physical properties of the mobile unit. In many practical cases the exact analytic form of this expression will not be known and must be estimated empirically. This quantity is integrated over the area of interest as a possible measure of coverage. In some alternative embodiments, a volumetric integral can be used. In some embodiments, the integral is approximated by a summation over discrete points.

The parameter rateᵢ represents the transmission bit rate used between the mobile unit i, and the access points. If the transmission rate is not symmetric two parameters can be used to describe it.

The tradeoff parameter λ₁ determines the weight given to mutual interference caused by transmissions from managed access points 14 in the solution. In some alternative embodiments, a function, rather than a constant. For example, value of the function can vary with the rate of packet transmissions (and thus the probability of mutual interference).

The tradeoff parameter λ₂ determines the weight given to mutual interference caused by transmissions from unmanaged access points 14. In some alternative embodiments, a function, rather than a constant, can be used. For example, the parameter can vary with the rate of packet transmissions (and thus the probability of mutual interference).

The summation index i is over the p unmanaged access points 14 or other sources of radio frequency interference.

The function f_{i,j,k}(channelⱼ, codeⱼ, rateⱼ, powerⱼ, channelₖ, codeₖ, rateₖ, powerₖ) represents the mutual interference experienced by mobile unit i from the managed access points, j and k, operating on channels, channelⱼ and channelₖ, using codes codeⱼ and codeₖ, transmission bit rates rateⱼ and rateₖ, and with power, powerⱼ and powerₖ. The variables channelⱼ, codeᵢ, rateⱼ, powerⱼ, channelₖ, codeₖ, rateₖ, powerₖ are under the control of the network management system. The function f_{i,j,k} represents many factors including, the physical properties of the access point (antenna configuration, etc.) the propagation conditions over the one or more paths from the access point to the mobile unit and the physical properties of the mobile unit. In many practical cases the exact analytic form of this expression will not be known and must be estimated empirically from measurements made by mobile units. This quantity is integrated over the area of interest as a possible measure of coverage. In some alternative embodiments, a volumetric integral can be used. In some embodiments, the integral is approximated by a summation over discrete points.

The quantity P(tⱼ,tₖ) represents the probability of two access points (j and k) transmitting a packet in overlapping time periods on the same channel and creating mutual interference for a mobile unit 16. A mobile unit may directly arrive at such an estimate or it may be determined by a controller in the radio network. This function weights the effect of mutual interference by the probability that two packets are received within the same period of time. Packets transmitted by the access points in non-overlapping time periods typically do not by themselves lead to mutual interference. In a more general sense, the probability if mutual interference may address more than two packets or access points. The likelihood of almost concurrent reception of three or more packets is very small, thus making it a less useful measure of interference.

The function f_{i,j,p}(channelⱼ, codeⱼ, rateⱼ, powerⱼ, channelₚ, codeₚ, rateₚ, powerₚ) represents the mutual interference experienced by mobile unit i between the transmissions from managed access points j and unmanaged access point p, operating on channels, channelₚ, with signal code codeₚ, at bit rate rateₚ, and with power powerₚ. The variables channelⱼ, codeⱼ, rateⱼ, and powerⱼ, are under the control of the wireless network management system, whereas the variables channelₚ, codeₚ, rateₚ, and powerₚ are not under the control of the network management system. The function f_{I,j,p} represents many factors including, the physical properties of the access point (antenna configuration, etc.) the propagation conditions over the one or more paths from the access point to the mobile unit and the physical properties of the mobile unit. In many practical cases the exact analytic form of this expression will not be know and must be estimated empirically from measurements made by mobile units. This function is likely to be the same or similar to the function used to represent the mutal interference between managed access points. This quantity is integrated over the area of interest as a possible measure of coverage. In some alternative embodiments, a volumetric integral can be used. In some embodiments, the integral is approximated by a summation over discrete points. A similar formulation can be used to model the signal effects from other sources of radio frequency interference (besides unmanaged access points).

The quantity P(tⱼ,tₚ) represents the probabilities of two access points 14 (one managed: j, and one unmanaged p) transmitting packets in overlapping time periods on the same channel and creating mutual interference for a mobile unit 16. In other words this function weights the effect of mutual interference by the probability that two or more packets are received within the same period of time. Packets transmitted by the access points in non-overlapping time periods typically do not by themselves lead to mutual interference. A similar formulation can be used to model the probability of signal collisions with other sources of radio frequency interference. The traffic levels or throughput of unmanaged access points is generally estimated from data (i.e. number of packets received over a period of time) collected by the mobile units. This measure may be generalized to address interference between more than two access points. However, in the preferred embodiment the probability of mutual interference is evaluated between two access points.

It will be clear to those skilled in the art, that Function 2 represents only one possible formulation. Alternative forms could use location specific formulations, for example. In another example, the problem could be formulated to eliminate the dependence on any one or all of the factors for individual mobile units 16, unmanaged access points 14, probability of packet collisions, etc. Yet other alternatives may only consider one or two of the channel, signal coding, transmission data rate or power setting parameters.

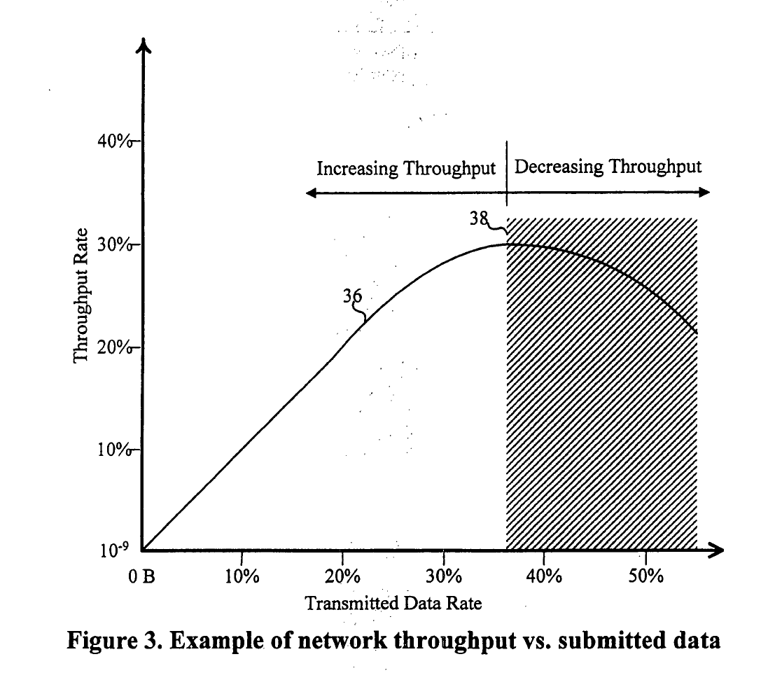

A wide variety of techniques can be used to create (often approximate) solutions to Equation 2 or other suitable formulations. Some suitable techniques are discussed below. In general, the goal is to find a set of channel, power, transmission data rate, and signal coding settings that maximizes the data throughput between the mobile units 16 and the access points 14 over the widest coverage area possible. FIG. 3 shows an example of throughput of a wireless network as a function of the rate of data packet transmission in a situation where there is mutual interference. In general, the mutual interference arises when more than one access point transmits packets on the same channel or overlapping channels, using the same or similar signal coding, in overlapping time periods and with similar received signal strength at the mobile unit. As has already been discussed, the transmission data rates of the interfering packets can also affect the degree of mutual interference experienced by the mobile units. The curve 36 shows the network throughput on a given channel versus the rate at which packets are transmitted. It will be understood that the shape of this curve and the numerical values on the axes are shown as an example only. The actual shape of the curves and numerical values will vary widely, depending on the exact configuration and transmission statistics of the network. At low transmission rates, the network throughput increases as the rate of packet transmission increases. At first, throughput increases nearly linearly with the rate of packet transmission increases. As the rate of packet transmission continues to increase the throughput begins to increase at a less than linear rate as the rate of packet collisions and resulting retransmissions increases. At still higher rates of packet transmission, the collision and retransmission rate becomes high enough that the throughput can enter state of decreasing throughput 38. In these situations throughput can be increased by either reducing the number of packets transmitted or by decreasing the mutual interference leading to the packet collisions. Alternatively, the spatial extent of the interference may be shaped, for instance, by modulating the relative power levels of the access points, to affect a smaller number of mobiles.

Function 2 helps to illustrate the relationship between throughput and mutual interference. The terms P(tⱼ,tₖ) and P(tⱼ,tₚ) indicate that when throughput in the wireless network is low, the chance of mutual interference is also low, since the probability of two or more packets being transmitted in overlapping time periods is also low. As the number of packets transmitted increases, the probability of packet collisions increases. In some cases, the optimum values of the parameters λ₁ and λ₂ can depend on the probabilities of packets colliding in overlapping time periods (P(tⱼ,tₖ) and P(tⱼ,tₚ)). In other words, the higher the likelihood of packet collisions, the greater the effects of mutual interference. For example, mutual interference between access points 14 with low transmission rates (and therefore low values of P(tⱼ,tₖ) or P(tⱼ,tₚ)) affects the reliability of communications with mobile units 16 less than mutual interference between access points with high packet transmission rates (and therefore high values of P(tⱼ,tₖ) or P(tⱼ,tₚ)). In cases with low packet transmission rates (and low potentiaI mutual interference), the transmission bit rate and transmission power of the access point can be increased without significantly affecting packet collision rates. Whereas, in cases with high packet transmission rates (and higher potential mutual interference), the transmission bit rate and transmission power of the access point may need to be decreased to limit packet collisions, but with a corresponding decrease in coverage area.

One can see from Function 2 that while reducing power on a given access point 14 can reduce mutual interference, the effective coverage area of the wireless network may also be adversely affected. Reducing the transmission power of the access points reduces the value of the function g_{i,j}(rateⱼ, powerⱼ), indicating reduced coverage area. At the same time, reducing transmission power of the access points reduces the mutual interference with managed access points, represented by the term f_{i,j,k}(channelⱼ, codeⱼ, rateⱼ, powerⱼ, channelₖ, codeₖ, rateₖ, powerₖ). Coverage area, as represented by the terms g_{i,j}(rateⱼ, powerⱼ), is also dependent on the transmission data rate. A lower data rate results in greater energy per bit (or symbol) transmitted (assuming other variables are held constant), giving a greater coverage area. The penalty for reduced data rate is reduced network throughput. A higher data rate results in lower energy per bit (or symbol) transmitted, giving less coverage area. These same terms indicate that selection of channels and signal coding for the access points, primarily affect mutual interference rather than the coverage area.

Given the tradeoff between coverage area and mutual interference, constraints must be applied to any practical algorithm for reducing mutual interference. Any suitable technique can be used to create and impose these constraints. Function 2 uses the parameter λ₁ and λ₂ to introduce these constraints. By changing the relative value of this parameter the balance between mutual interference and coverage area can be made. This balance is necessary to prevent undesired or degenerate solutions from being computed. An example of a degenerate solution is reducing the transmission power of the managed access points to zero. While mutual interfere cased by the managed access points would be eliminated with this solution, the wireless network would be useless, since the coverage area would likewise be reduced to zero. At another extreme, the power of all access points could be increased to the maximum value allowed. In this case, coverage area is maximized, the affects of mutual interference with unmanaged access points is minimized, but mutual interference between managed access points will be at a maximum.

If mutual interference is experienced from unmanaged access points 14 (the terms f_{i,j,p}(channelⱼ, codeⱼ, rateⱼ, powerⱼ, channelₚ, codeₚ, rateₚ, powerₚ)) or from other radio services or sources of radio frequency energy, the optimum values of λ₂ may, in some cases, be changed. For example, the mobile units 16 may experience improved communications reliability and greater data throughput when the managed access point power levels are increased to compensate for mutual interference with the unmanaged access points. This solution potentially increases the mutual interference between managed access points, while at the same time providing a higher SNR at the mobile units receivers, partly overcoming the mutual interference from the unmanaged access points. Alternatively, or in addition, the transmission data rate of the managed access points, rateⱼ, can be reduced, increasing the energy per bit and the likely effect of the mutual interference. The penalty for reduced data rate is reduced network throughput.

The degree to which nearby access points 14 create mutual interference depends upon several factors including, the channels and signal coding used by the transmitting access points. The functions f_{i,j,k}(channelⱼ, codeⱼ, rateⱼ, powerⱼ, channelₖ, codeₖ, rateₖ, powerₖ) and f_{i,j,p}(channelⱼ, codeⱼ, rateⱼ, powerⱼ, channelₚ, codeₚ, rateₚ, powerₚ) in Equation 2 are to some extent dependent on the degree of channel and signal coding overlap between interfering access point transmissions. In some cases, access points will transmit on channels that only overlap slightly (i.e. only side lodes of signals overlap), in which case mutual interference is unlikely. In some other cases, the access points may transmit on the same channels, increasing the chances of mutual interference. In other cases, the access points may transmit in channels with overlapping frequency bands, increasing the chances of mutual interference. In yet other cases, the two or more orthogonal codes (perhaps applied through FHSS or DSSS) may be used to separate the potentially mutually interfering signals. In most cases, the greater the degree of frequency (channel) and coding separation that can be achieved the greater the access point transmit power that can be used without adverse mutual interference. The bit rates (rateⱼ, rateₖ, and rateₚ) used for transmissions by the managed and unmanaged access point can change the effects of mutual interference, as is discussed elsewhere in this document.

Based on signal measurements made by the one or more mobile units 16 it is possible to determine the coverage areas and mutual interference created by the access points 14. These measurements may be combined and processed to extract meaningful estimates of coverage and mutual interference. These estimates are used to determine neighbor relationships between the access points. The channel selections, transmission data rates, and power settings are then optimized based on these measurements. The measurement and optimization process can be repeated periodically. Thus, the process can adapt to changes in the environment and in the configuration of the wireless network.

Additional Formulation

An alternative formulation to Equation 2 can be created as a constrained optimization problem. One approach is to solve Equation 2 subject to constraints. The constraints can be equality constraints, inequality constraints, or both. Some examples of suitable constraints include:
1. a fringe coverage signal strength threshold, that sets the minimum desired signal strength at the edges of the network; and,
2. the minimum signal to noise ratio (SNR) required to minimize mutual interference.
   Overview of System

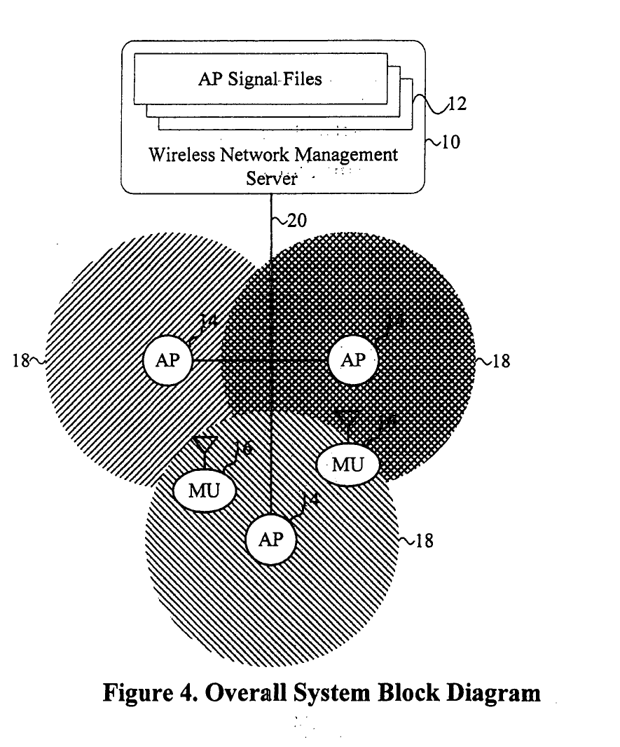

The channel, coding and power management system collects data from one or more mobile units 16 and uses this information to optimize the throughput of the wireless network by determining and setting channel, signal coding, transmission data rate, and power parameters in the access points 14. A simplified block diagram for some embodiments of the present channel, coding and power management system is shown in FIG. 4.

The wireless network management server 10 connects to the access points 14 via a backbone network 20. The backbone network can comprise any number of sub-networks connected by one or more backbone segments. The network segments can be comprised of any combination of wired or wireless links. The wireless network management server can be connected at any suitable location on the network. Further, the wireless network management server can be distributed across the network in any manner desired. Finally, in some embodiments, the wireless network management server can be contained in one or more of the access points.

The one or more access points 14 communicate with one or more mobile units 16, which are within the coverage area 18 of the access point. A coverage area is the geographic region where the signal strength is adequate for the mobile unit and access point to communicate effectively. It will be understood that the coverage for even the same access point can be defined in different ways, even at the same time. For example, a mobile unit with a higher-gain antenna or a lower noise receiver may be able to communicate adequately, and therefore experience a larger coverage area when compared to a lower performance mobile unit. In another example, a mobile unit sending packets at a low data rate may be able to tolerate a high packet retransmission rate without experiencing performance degradation. Such a mobile unit will experience a larger coverage area from a given access point than a mobile unit receiving at a high packet rate for a time critical application, such as streaming video.

As the mobile units 16 roam throughout the wireless network they roam from one coverage area 18 to another. The mobile units collect strength information for the signals received from the access points, along with network performance data. In some cases, the mobile unit will receive signals from several access points 14 at a given location. Occasionally, the mobile units send the collected information to the wireless network management server 10 thought the access points and network 20.

The wireless network management server 10 collects the data, received from the mobile units 16, in the AP signal files 12. The server uses this information to compute channel, signal coding, transmission data rates and power level settings for the access points 14, in order to optimize the throughput of the wireless network. Once the channel, coding, transmission data rate and power settings have been computed, the server transmits them through the network 20 to the access points. In some embodiments, the wireless network management server sends messages to specific Simple Network Management Protocol (SNMP) Management Information Bases (MIBs) to set the channel, signal coding, transmission data rate, and power parameters for the access points.

In some alternative embodiments, the wireless network management server 10 can be integrated with one or more access points 14. These alternative embodiments may also place the AP signal files 12 on one or more access points.

Measurement of Mutual Interference

In some embodiments, the mobile units 16 make and record measurements of the quality of the signals received from the access points 14. As the mobile units roam through the wireless network they move from the coverage areas 18 of one access point to another. On occasion, the mobile units receive signals from one or more of the access points when coverage areas overlap. These signals could be the result of a transmission of a message to that mobile unit or another mobile unit or a beacon or broadcast message transmitted by the access point. The mobile units record signal quality measures which can include, an access point identifier, the Received Signal Strength Indicator (RSSI), statistics on packet transmission rates, packet reception rates, and packet retry or retransmission rates. At periodic time intervals, these measurements, or alternatively, quantities based on one or more of them, are transmitted from the mobile units though the access points and the network 20 to the wireless network management server 10. The server stores these data in the AP signal file 12.

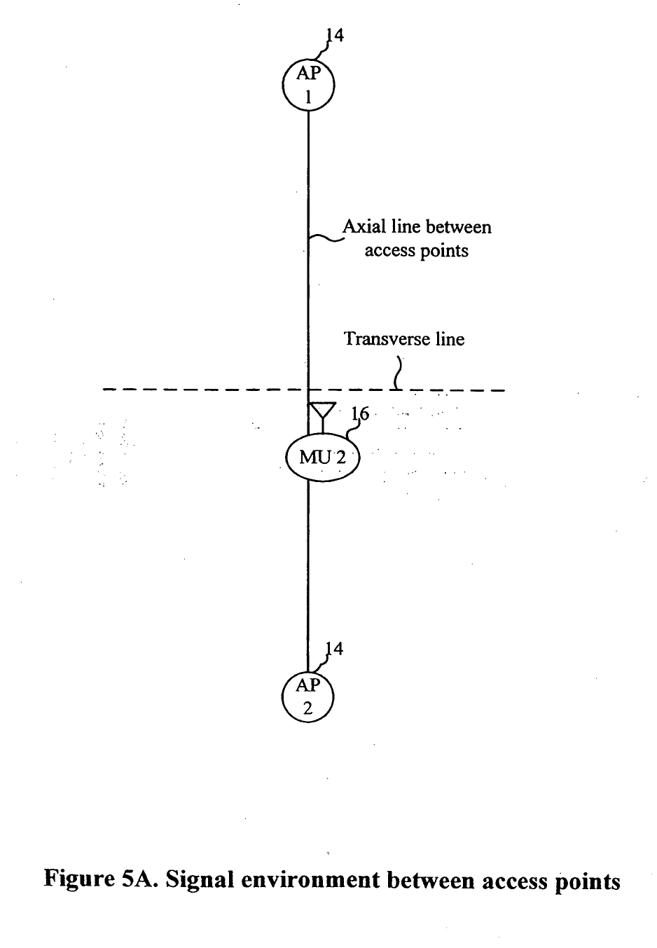

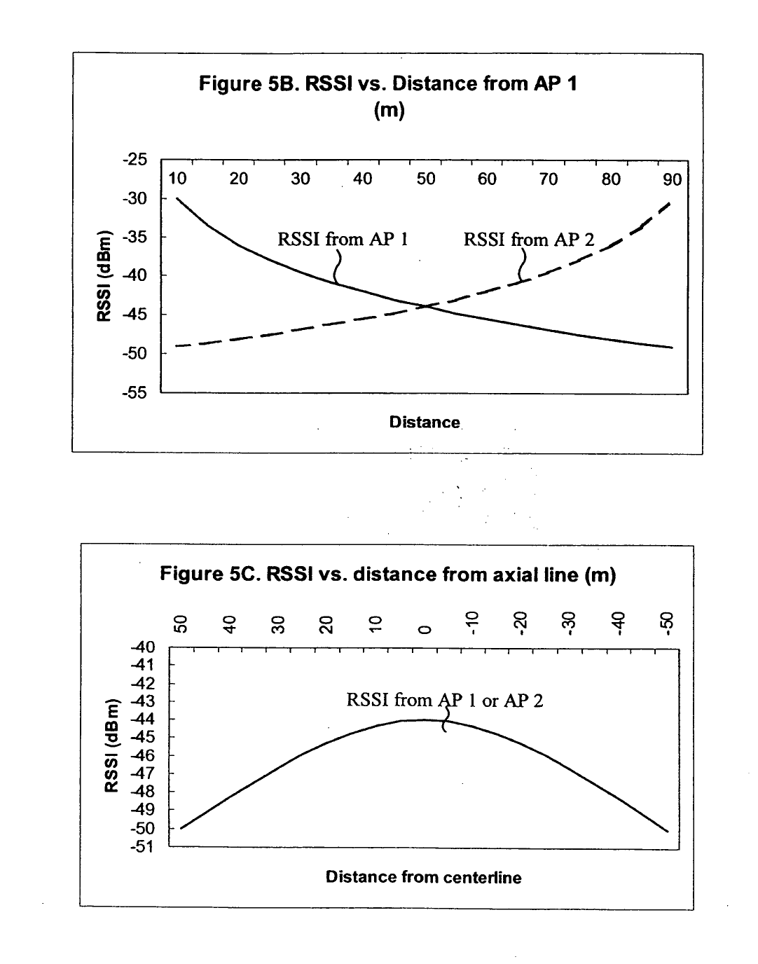

FIG. 5A shows a simple conceptual experiment in which mobile unit 16 travels in the area between the access points 14 AP 1 and AP 2. In this example the two access points are 100 meters apart and the RSSI at the mobile unit's receiver at 10 meters from either access point is −30 dBm (and assuming the transmission power and antenna characteristics of the access points is identical).

As the mobile unit 16 moves from a point 10 meters from access point 14 AP 1 along an axial line toward access point AP 2 the RSSI from AP 1 will decrease. The solid line in FIG. 5B shows an example of the RSSI from AP 1, as experienced by the mobile unit, as it moves along this axial line. The dashed line in the figure shows the RSSI, experience by the mobile unit, from AP 2 at the same time. For the purposes of this example only, the decrease in signal strength is modeled as the square of the distance. Those skilled in the art will recognize that the model used here is simplified and that in most real-world situations received signal strength exhibits more complex relationships with distance. Further, the signal strength values shown are provided only for illustrative purposes.

As the mobile unit 16 moves along a line transverse to the axial line, between the access points 14 AP 1 and AP2, the RSSI decreases with distance from the axial line. FIG. 5C illustrates this behavior. The same behavior would be observed along any line transverse to the axial line. Again, for the purposes of this example, the decrease in signal strength is modeled as the square of the distance. Those skilled in the art will recognize that the model used here is simplified and that in most real work situations received signal strength exhibits more complex relationships with distance. Further, the signal strength values shown are provided only for illustrative purposes.

From the simple example shown in FIGS. 5A, 5B, and 5C it can be seen that the potential for mutual interference is greatest on the transverse line which crosses the axial line at the midpoint between the two access points 14. Along this line the signal strength received by the mobile unit 16 from either access point is equal. Thus, if packets are received from both access points in an overlapping time period the probability of both packets being received with errors is high. In other words, the signal to noise ratio between the desired packet and the interfering packet is or is close to 0 dB. Further, the point at which the mobile unit is closest to the access points along the transverse line is at the point of intersection with the axial line or at the point where signal strength along the transverse direction is at a maximum. Thus, in this simplified example, a mobile unit could locate the midpoint between the access points (the point at which the mobile unit is equidistant from but closest to both access points) using only signal strength measurements. In this example, the mobile unit could travel the region between the access points measuring and recoding RSSI. The point at which the signal strengths from both access points are approximately equal, but at a maximum value given the equality constraint, is the approximate midpoint between the access points.

In more complex, real-world situations, the relationships between the position of the mobile unit 16 with respect to the access points 14 will not be so simple or ideal, as the foregoing example. Real-world radio frequency propagation will experience a number of affects including the use of less than ideal atennas, differing and variable antenna polarizations, signal shadowing from objects in the envirornent, multi-path propagation, and signal scattering. In the real world it may not even be possible for the mobile units to travel along the axial and transverse lines illustrated in FIG. 5A. Further, the points, lines or regions where the signal strengths from two access points are nearly the same can have a somewhat arbitrary shape. In some cases, there may be several, possibly discontinuous, sets of these points, lines or regions.

Given the real-world complexity of radio frequency propagation, the technique previously described can still be applied. The mobile units 16 can make and record measurements of RSSI as they travel between the coverage areas 18 of the access points 14. The mobile units can discover points, lines or regions where the signal strength between two access points are the same or nearly the same. This 0 dB signal strength ratio indicates that the radio frequency propagation “distance” (or path loss) to the two access points is or is nearly identical. Of the several possible points, lines or regions with equal or nearly equal signal strength the one, or possibly more, of these points, lines or regions can have the strongest signal strength (from both access points). Thus, these points, lines or regions can be the closest to the access points while still being equidistant, in terms of radio frequency propagation or path loss and can be considered an approximate midpoint. The forgoing discussion assumes that other signal strength effects, such as transmit antenna gain, receive antenna gain, mobile unit receiver characteristics, and transmission power are nominal or have been corrected for. A more complete discussion of these correction factors is presented below.

Determination of Neighbor Relationships

From the forgoing discussion it can been seen that a measure or approximate measure of distance between access points 14 can be determined using the RSSI measurements of the mobile units 16 alone. These values computed from the RSSI measurements can represent the distances between the access points in terms of radio frequency propagation or path loss, rather than geographic distances. In other words, these measurements provide a predictor of signal strengths of potentially interfering transmissions from different access points. Given that the coverage areas 18 of access points and mutual interference between access point transmission depend on radio frequency path loss, they can be more representative of expected coverage area and mutual interference than simple geometric models.

Using signal strength based models, neighbor relationships between access points 14 can be determined. Basing these neighbor relations on signal strength or path loss can better represent the, possibly overlapping, coverage areas 18 and potential for mutual interference than geographic measures. Based on the path loss computed from the RSSI measurements, the neighbor relations between the access points can be classified. In some embodiments, neighbor relations will be classified as near or far, depending on value of the signal strength measurement. A threshold value can be used to set the cutoff points. Referring to FIG. 2, in some embodiments, this threshold value can be set at the point the signal to noise ratio 30 in the mobile unit's receiver transitions between the adequate region and the low signal to noise ratio region 32. In other cases, a network administrator can determine the threshold manually.

Clearly, other classifications of neighbor status for access points 14 could be used. For example, in some embodiments, neighbor status could be classified as near, intermediate and far. The intermediate classification could be used for signal to noise ratios near the boundary between the unacceptable 32 and acceptable signal to noise ratios. In yet other embodiments, more granular classification schemes could used. For example, several levels of neighbor relationships can be defined to any depth.

In some alternative embodiments geographic information can be used to define neighbor relationships between access points 14. In yet other alternative embodiments, neighbor information based on signal propagation can be combined with prior information on geographic location of access points, and possibly mobile units 16, can be used. This approach combines information on the signal environment as experienced by mobile units with geographic location information.

It will be understood that the examples shown in this section assume that all power correction factors are nominally identical. Possible power correction factors include, access point 14 transmission power, access point antenna characteristics, mobile unit 16 antenna characteristics, and mobile unit receiver characteristics. A more complete discussion of these correction factors is presented below.

Network Throughput Measurements

As has already been discussed, the mobile units 16 make and record measurements of the signal strength for packets received from the access points 14. In some embodiments, the mobile units and the wireless network management server 10 can also make and record other measurements of wireless network quality or throughput, at the same time. Examples of these measurements include packet transmission rates, transmission data rates, packet collision rates, and packet retransmission-rates. These measurements allow network utilization or data throughput to be computed and recorded. Some of these measurements can be made on the interconnecting network 20, by the access points, by the wireless network management server or other suitable network performance monitoring system, or on the wireless network by the mobile units and access points. In some embodiments, these measurements can be used to determine the quantities P(tⱼ,tₖ) and P(tⱼ,tₚ) for equation 2.

As an example, if two access points 14 are using the same or overlapping channels, the same or similar signal coding, and a mobile unit 16 receives multiple packets within overlapping time periods, a packet collision results. If the ratio of the signal strengths is close to one (similar signal strengths), the signal to noise ratio at the mobile unit's receiver will not be sufficient to accurately decode either packet. In this case, the mobile unit may need to request a packet retransmission, even in cases of relatively strong signals. This limitation on wireless network throughput is a direct result of the mutual interference between packets transmitted by two or more access points. The probability of this type of mutual interference can be computed from the rate of packet transmission by the interfering access points.

As an example, if a first access point is operating with a throughput of 0.1 (e.g. the access point is transmitting or receiving a packet 10% of the time) and a second access point is operating with a throughput of 0.15, then the probability of a packet collision is 0.015. In other words, on average 1.5% of packets transmitted would collide and may need to be transmitted. Data to perform these calculations can be collected by monitoring the fixed wire network 20 by the wireless network management server or other suitable monitoring system. Mobile units and access points can collect data on the performance of the wireless network. Those skilled in the art will recognize that the throughput of any data network is highly variable. Traffic on the network will vary with the loads presented by the individual mobile units 16, fixed computers and servers. In some cases, the load created by the mobile units will depend on the activities of the users, such as, running applications, downloading data and uploading data. This load can be presented at seemingly random times (at least from the point of view of network monitoring systems), since it heavily depends on the activities of individual use. The load on a multi-user network can be determined by the sum of this (collective) behavior over time. Thus, the total observed traffic load or throughput is based on a average of seemingly random events and can be expected to have some structure over time. Typical observed behavior can include, busy time periods and less busy time periods. These fluctuations can be measured over a wide range of time periods. In general, the shorter the time period considered, the greater the random fluctuations expected between the time periods. When longer time periods are considered (i.e. hours or days), the network load can become more predictable. For example, it can be possible to predict the peak busy hour and traffic in this period. As shorter time periods (i.e. minutes or seconds) are considered the fluctuations from time period to time period generally become larger.

From the forgoing discussion, it can be seen that the throughput experienced at each access point will be highly variable over short periods of time. Thus, the degree to which mutual interference is experienced can fluctuate significantly in time. Viable network management solutions should account for this expected variability in mutual interference. Typically, some measure of peak network activity will be used in estimating mutual interference. Examples of techniques that can be used to characterize peak network activity can include:
1. Determine a representative time period (i.e. some number of minutes) and identify the peak average (mean) or median load within one of these time periods over a somewhat longer period of time (e.g., days, weeks or months);
2. Determine a representative time period (i.e. some number of minutes or seconds) and compute an average (mean) or median over some number of peak load measurements (possibly taking a mean or median over each time interval) from within these periods over a longer period of time (e.g., days, weeks or months);
3. Use probabilistic, rule-based or fuzzy set measures to determine if the throughput measurements are a member of the group or class representative of the peak traffic at the access point, and to which other estimators may then be applied; and,
4. use of adaptive or evolutionary estimation models (e.g., genetic algorithms, simulated annealing, clustering algorithms, and non-parametric regression) to the throughput measurements to determine a quantity representative of the peak traffic at the access point.

It will be clear to those skilled in the art, that use of the above techniques or other suitable techniques to characterize peak access point throughput will require several parameters be determined. In some embodiments, these parameters can be set manually by a network administrator, possibly using the system reporting capabilities (discussed below). Alternatively, or in addition to, parameters may be automatically determined by the system.

These additional network measurements can be used by the wireless network management server 10 to improve the management of access point 14 channel, signal coding, transmission data rate, and power settings computed by the wireless network management server 10. For example, a high rate of packet retransmission to mobile units 16, in cases with sufficient signal strength can indicate mutual interference between the signals of one or more access points. In some embodiments, the server can use these data to predict the expected mutual interference given a set of access point 14 channel, signal coding, transmission data rates and power settings. These predications can then be used to improve the trade-off between network coverage area 18 and mutual interference. In other embodiments, a network administrator will examine these data to optimize this trade-off. In yet other embodiments, the process can be partially manual and partially automated. In some embodiments, this process involves setting trade-off parameters, such as λ₁ and λ₂ in Equation 2. Further discussion of management of the trade-off between network coverage area 18 and mutual interference is described below.

Coverage Measurements

As the mobile units 16 roam through the wireless network they move from the coverage areas 18 of one access point 14 to that of another. As an example, at the fringes of the wireless network coverage areas, the mobile units will experience low signal strength leading to errors in the received packets. In these cases retransmission will likely be required for a significant fraction of packets. In some cases, the mobile unit may receive transmissions from several access points. For example, a mobile unit may be able to receive probe responses from several access points at any one time. In cases where the signal strength of one of these transmissions is greater than the others, the mobile unit may associate with that access point. In other cases, none of the access point transmissions received by the mobile unit have the desired RSSI. In these cases, the mobile unit can be considered to be on the fringe of the network coverage area. In some other cases, a mobile unit may receive transmission from only one access point (or only one access point with sufficient signal to decode the transmissions), but with low RSSI, the mobile unit can be considered to be on the fringe of the network coverage area, and can be located to the coverage area of that single access point.

As the mobile units 16 move through low RSSI portions of the access point 14 coverage areas 18 they record the lowest measurements experienced within the coverage area. At the same time, RSSI measurements for signals received from other access points (if any) are recorded. In this way, the signal strengths and access point identifiers at the fringe of the coverage area are observed, recorded and then reported to the wireless network management server 10 for storage in the AP signal files 12.

Combining the information on the access point 14 identifiers with the RSSI data, poor coverage areas 18 can be identified. Once collected, the wireless network management server 10 can use these data as the basis to infer coverage areas. In some cases, maintaining a minimum required signal strength in these fringe coverage areas can be treated as a constraint (i.e. a linear constraint on solutions of Equation 2) when determining access point transmission power. In other cases, no solution will provide the required coverage while maintaining acceptable levels of mutual interference. Some embodiments will compute the best acceptable solution and report information that can be used to site additional access points for deployment.

Relationship Between Transmission Power and Mutual Interference

Access point 14 transmission power and the likelihood of mutual interference with neighboring access points have an inverse relationship. The greater an access point's transmission power the greater its coverage area 18, and the greater the likelihood that a nearby mobile unit 16 will associate with it. The increased likelihood of a mobile unit associating with the access point is determined both by the increased coverage area with acceptable RSSI and the higher RSSI for that access point within coverage areas overlapping with other access points. As a result of the increased likelihood of mobile units associating with the access point, a greater traffic volume or throughput can be anticipated for that access point, and with a corresponding increase in likelihood of packet collisions from mutual interference (assuming traffic remains approximately constant for the interfering access point). Conversely, the likelihood of mobile units associating with an access point decreases as the transmission power decreases. The traffic volume of throughput will, therefore, likely decrease, with a corresponding likely decrease in packet collisions from mutual interference (again assuming traffic remains approximately constant for the interfering access point).

From the forgoing discussion it can be seen that one technique to reduce mutual interference is to reduce the transmission power of the interfering access points. These effects can contribute to the tradeoff between coverage and mutual interference. As an example, the quantity P(tⱼ,tₖ) in Equation 2, the probability of collision within the same time period of packets transmitted by the access point j and the access point k, is dependent on g_{i,j}(powerⱼ, rateᵢ) and g_{i,k}(powerₖ, rateₖ), the signal strengths experienced by the ith access point from access point j and access point k.

Reporting

In some embodiments, the network performance data described above can be used to create reports and charts showing the state of the wireless network to administrators. In some embodiments, the administrators may use an interface to the wireless network management server 10 to examine, chart and report on the data contained in the AP signal files 12. Using these reports and charts, network administrators can assess the performance and throughput of the network. In some embodiments, the charts and reports can be used to determine and assess placement of redundant or offline access points 14. In some other embodiments, the charts and reports can be used to determine if there is a need for a new access point to be added to the network or if there is an access point that could be removed from the network to improve throughput. In some other embodiments, the reports and charts can be used to determine which access points may require manual configuration, in cases where automatically computed solutions are not useful. This may be necessary if there is insufficient data in the AP signal files 12 to automatically determine a good solution. Some examples of reported data can include:
1. tabular listings or time-based charts for signal strength and signal strength ratio for pairs of access points 14;
2. tabular listings or time-based charts indicating the quantity and quality of signal measurements by access point or pair of access points 14, and possibly indicating access points for which insufficient information has been collected to compute a good solution;
3. tabular listings or charts indicating access points 14 with the most significant constraints on solutions for settings;
4. tabular listings or time-based charts indicating network throughput or other network performance metrics, which may be organized by access point 14;
5. tabular listings or time-based charts indicating packet transmission rates or retransmission rates, which may be correlated with low signal strength, indicating poor coverage, and which may be organized by access point 14 or access point pairs;
6. tabular listings or time-based charts indicating areas with high retry or retransmission rates and yet with good signal strength, which may be indicating the presence of unmanaged access points or other sources of radio frequency interference, and which may be organized by access point 14 or access point pairs;
7. tabular listings or graphical representations showing the neighbor relationships (geographic or based on signal propagation) and signal strength data between the access points 14; and,
8. maps of access point 14 coverage areas 18, signal strengths, traffic statistics, channel settings, code settings, and power settings, indicating areas of poor coverage (poor or no alternatively access points covering an area).

9. Reports showing performance statistics segmented by access point.

In some embodiments, the reports may include information intended to help system administrators better manage the wireless network. For example, these reports can contain suggested actions that system administrators may then wish to undertake, and can include:
1. Reports indicating the possible need to deploy an additional access point in a particular area;
2. Reports indicating that an access point in a particular area may be redundant; and
3. Reports indicating a better selection of channel, transmission data rate or signal code settings for an access point.

In some embodiments, a graphical or tabular view is used to interactively access reports. In some cases, the display reflects the organizational hierarchy of the wireless network. For example, the hierarchy used to organize access to reports can reflect the sub-network structure of the back overall network. In another example, the hierarchy can reflect the geographic placement of the access points 14 (i.e., by location, by building, floor, room, etc.). In other embodiments, the access points can be accessed and viewed by other organizations, such as names or numbers or simply in a flat structure. In yet other embodiments, the access points can be accessed and viewed by various depths of signal propagation based neighbor relationships between the access points.

In some embodiments, reports and charts for a given access point 14 can be presented in a “root and branch format”. In these cases, when a particular access point is selected it is displayed in a graphical or tabular format showing the near neighbors (or nearest neighbors) of the selected access point. At the same time, summary statistics in tabular or graphical form can be presented for the selected access point. Tabular or graphical information on access point pairs can then be accessed by selecting the particular pair or pairs of interest. At the same time, a similar root and branch organized data presentation can be made available for the other access point in the pair.

In some embodiments, the interfaces used for the display of network performance and alarm conditions can also be used to control the management of power, channel, transmission data rate, and code settings. As an example, a network administrator may use a display of a report on the performance of a particular access point 14 or set of access points to interactively initiate a session to change the settings for one or more access points. In another example, an alarm display (see below) can include capabilities allowing the administrator to interactively take action. In another example, the interface can allow administrators to activate or deactivate access points, while viewing displays showing the consequences of their actions. In another example, the new, automatically determined, settings for access points and possible predicted consequences can be presented to network administrators through the interface. The administrators can then approve or reject any changes. In yet another example, the interface can be used to create manual settings for one or more access points and to indicate that these settings are not to be changed automatically (a manual override option). In some embodiments, these functions can be integrated with general purpose network administration tools.

In some embodiments, the wireless network management server 10 can generate automatic reports or alerts for cases where network performance problems arise. Some examples of conditions that could trigger these alerts or reports can include:
1. mobile units 16 experiencing poor coverage at the fringes of coverage areas 18 of some access points 14, which may indicate the need to change access point settings or deploy additional access points;
2. excessive collisions of packets transmitted by two or more access points 14, as experienced by the mobile units 16, possibly indicating high levels of mutual interference;
3. rapid or sustained changes in time of quantities such as highest combined signal strength, signal ratios, or packet retransmission rates, which can be computed by various types of edge detection filters, and possibly indicating the network environment has changed;
4. measured or computed quantities indicating the failure of one or more access point 14; and,
5. reduced network throughput experienced by the mobile units 16, possibly indicating mutual interference or saturated access points.

In some embodiments, a graphical and tabular interface or interface using a root and branch structure can be used to display alerts. More information on the organization of these displays has been given above. In some cases, the access point 14 or access points displayed will be highlighted (e.g., as green, yellow or red status) when an alarm condition occurs. In other cases, a display showing the alarm condition and perhaps information on near (or nearest) neighbor access points can be automatically displayed when an alarm or alert condition occurs. In some embodiments, an email, page, telephone call or other alert can be created when an alarm or alert condition occurs.

Operator Imposed Constraints

In some embodiments, an operator or system administrator may impose specific values on control variable or place constraints on control values computed in an automatic solution produced by the wireless network management server 10. These values and constraints will typically be manually set through a user interface. Some examples of these values and constraints can include:
1. Set an access point to always use a particular channel;
2. Restrict an access point from using a particular channel or channels;
3. Set a minimum or maximum value on the transmission power of an access point;
4. Set a value for the transmission power of an access point;
5. Set an access point to always use a signal coding;
6. Restrict an access point from using a particular signal coding or signal codings;
7. Set a minimum or maximum value on the transmission date rate of an access point; and
8. Set a value for the transmission data rate of an access point;
   A Simplified Example

This section presents an example of determining the optimized access point 14 channel and power settings. It will be understood that this example has been simplified to be illustrative of the concepts discussed and is not to be considered the only or even best approach.

The example presented is based on a number of simplifying assumptions including:
1. All RSSI measurements have been normalized to an access point transmission power of +100 dBm (the assumed maximum) and a 0 dB antenna gain;
2. Any variation in the receiver and antenna characteristics of the mobile units have been normalized out;
3. Three independent (non-overlapping channels) are available for transmissions;
4. It is assumed that all transmission data rates are identical for all access points, and thus cannot be set;
5. It is assumed that all signal coding is identical for all access points, and thus cannot be set;
6. Assume minimal variability in signal levels (e.g. due to multi-path propagation);
7. The minimum desired signal strength is −80 dBm (i.e. a 10 dB margin over the −90 dBm required for at a bit error threshold of 10⁻⁶), assuming no mutual interference present; and,
8. The minimum required SNR is +11 dB continuing the example shown in FIG. 2).

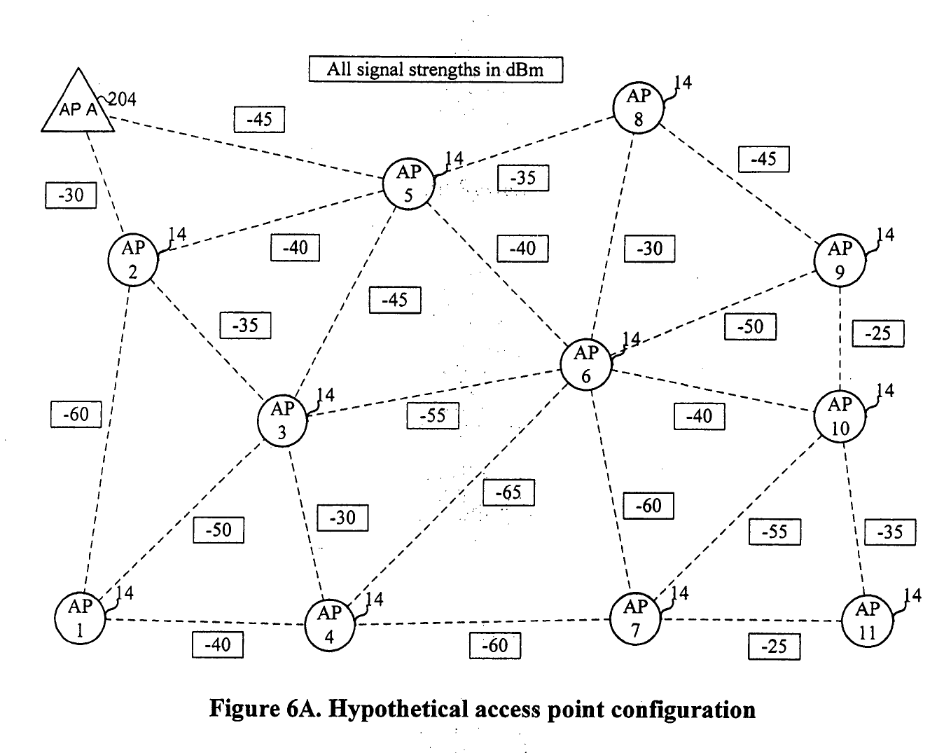

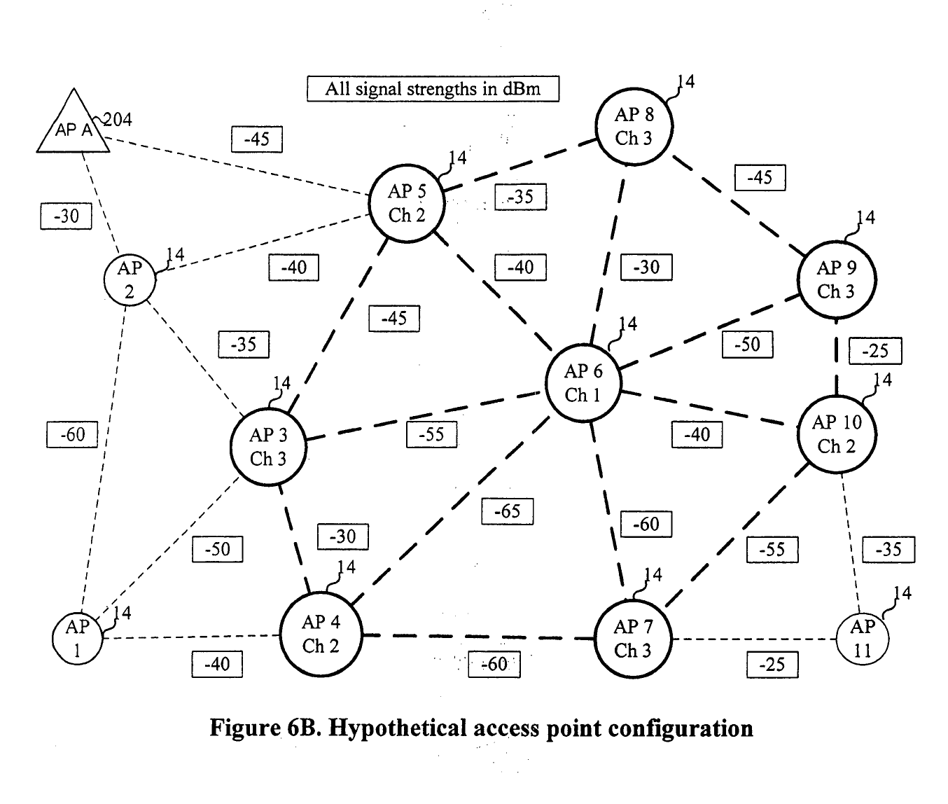

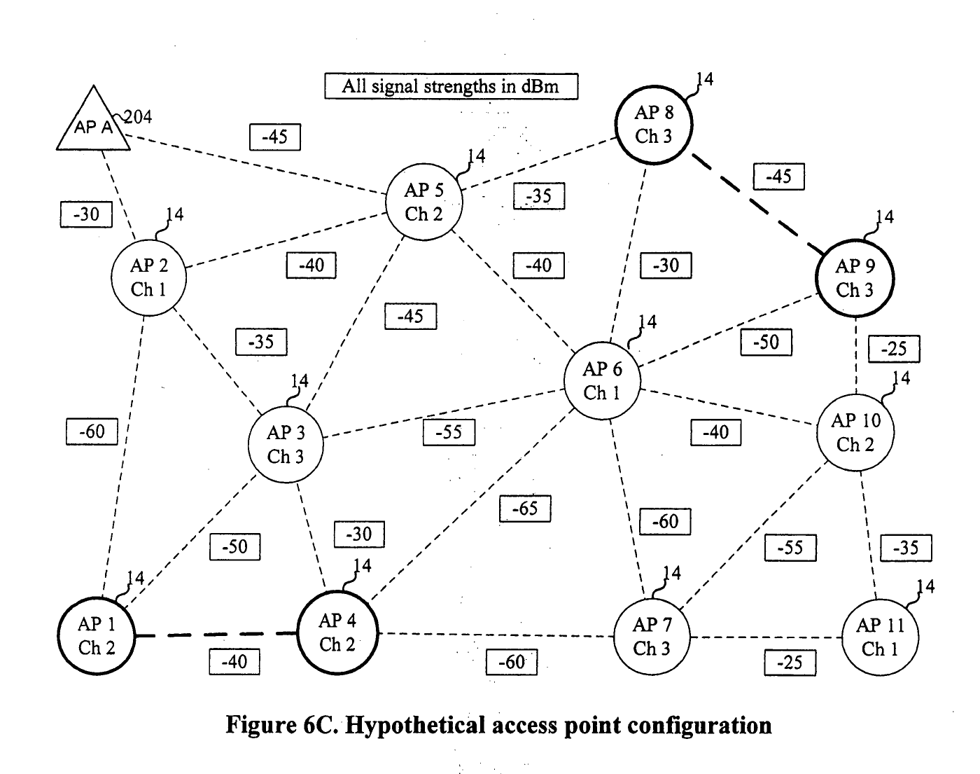

The network configuration for this example is shown in FIG. 6A. There are 11 access points 14 under management (access points and one unmanaged access point (AP A), which is presumed to be foreign to the network. Mobile AP1 through AP 11) units 16 roam across the coverage area of this network collecting and recording RSSI measurements for the signals received from the various access points. These measurements are transmitted to the wireless network management server 10 and stored in the AP signal files 12. At the same time, the server and the mobile units collect traffic statistics on the network.

Nearest neighbor relationships between the access points 14 are determined by the wireless network management server 10. In this example, a threshold is applied to the maximum signal strength at the midline (i.e., the line along which the measured RSSI from a pair of access points is close to identical). This technique has been described in a previous section. In this example, a threshold of −70 dBm, is used to determine nearest neighbor relationships. In other words, the midpoint RSSI must be greater than −70 dBm for the relationship to be considered to have nearest neighbor status. The result is shown in FIG. 6A. Dotted lines connect the access points 14 with their nearest neighbors. The maximum signal strength at the midpoint (in terms of radio frequency propagation) is shown in the rectangular box near the lines connecting neighboring pairs of access points.

Table 1 shows a list of the managed access points 14 in inverse order by the number of constraints. In this example, the number of constraints is shown in the second column, and is determined, by the wireless network management server 10, by counting nearest neighbors (including unmanaged access points). The peak throughput for each access point is shown in the third column. Methods for the determination of peak throughput have been previously discussed. The fourth column of the table shows the lowest signal experienced by mobile units 16 at the margin of the network. Methods to determine the signal strength at the margin of the network coverage area have already been discussed. There are no entries in the table for the unmanaged access point, AP A, since its settings are not alterable by the wireless network management server.

TABLE 1

| Access | Number of | Peak | Signal at | Channel | Power |
|---|---|---|---|---|---|
| Point | Constraints | Throughput | Margin | Assignment | Setting |
| AP 6 | 7 | 0.25 | −75 dBm | — | — |
| AP 5 | 5 | 0.22 | −70 dBm | — | — |
| AP 3 | 5 | 0.18 | −65 dBm | — | — |
| AP 10 | 4 | 0.18 | −80 dBm | — | — |
| AP 7 | 4 | 0.15 | −70 dBm | — | — |
| AP 4 | 4 | 0.10 | −85 dBm | — | — |
| AP 9 | 3 | 0.25 | −60 dBm | — | — |
| AP 8 | 3 | 0.09 | −80 dBm | — | — |
| AP 2 | 4 | 0.18 | −75 DBm | — | — |
| AP 1 | 3 | 0.15 | −85 dBm | — | — |
| AP 11 | 2 | 0.05 | −50 dBm | — | — |

The most constrained access point 14 in Table 1 is AP 6, with 7 constraints or nearest neighbors. Thus, this access point is used as a starting point The wireless network management server 10 can set the channel for this access point to any value (within the set of channel 1, channel 2 or channel 3), and in this example, channel 1 is selected arbitrarily.

Starting with the initial access point 14, the wireless network management server 10 will determine the most constrained access points that are neighbors of this initial access point (AP 6). In this case, AP 5 and AP 3 are the most constrained near neighbors (with 5 constraints each). AP 5 is more active (with a throughput of 0.22) than AP 3 is taken first. Thus, in this example, access point throughput is used as the tie breaking criteria. An alternative tie breaking criteria, having the unmanaged access point as a near neighbor, could have been applied to produce the same result. The only unused channel (not used by a near neighbor) is channel 2, since AP 6 is using channel 1 and the unmanaged access point, AP A, is using channel 3. In turn, AP 3 is assigned the only available channel, channel 3, since AP 6 is using channel 1 and AP 5 is using channel 2.

Once channels have been assigned to the most constrained neighbors of access point 14 AP 6, the wireless network management server 10 computes channel assignments for the next most constrained group of neighbors (AP 10, AP 7, and AP 4), each with 4 constraints and no unmanaged access points as neighbors. The order may be selected based on the peak access point throughput (0.18 for AP 10, 0.15 for AP 7, and 0.10 for AP 4). The server assigns channel 2 to AP 10. It will be noted that given the lack of constraints (AP 1 is the only near neighbor with an assigned channel), channel 3 could also have been assigned. Given the constraints imposed by near neighbors (AP 6 using channel 1 and AP 10 using channel 2), AP 7 is now assigned channel 3. Finally, access point, AP 4, is assigned the only free channel (AP 6 using channel 1, and AP 3 and AP 7 both using channel 3), channel 2.

The next most constrained neighbors of access point 14 AP 6, AP 9 and AP 8, are considered by the wireless network management server 10. AP 9 has the higher peak throughput, 0.25 as compared to 0.09 for AP 8. The only free channel is channel 3, since AP 6 is assigned channel 1 and AP 10 is assigned channel 2. The channel assignment for AP 8 presents a particular problem, since there are no free channels, with AP 6 using channel 1, AP 9 now assigned channel 3 and AP 5 assigned channel 2. The server determines that none of these near neighbors can easily be assigned another channel (all have near neighbors using the other two channels). In cases, where orthogonal signal codes can be assigned, or overlapping channels can be assigned, either one or both of these alternatives could be applied. In this simplified example these options are not available. Thus, the server must determine if the potential mutual interference with AP 6, AP 9 or AP 5 will be the least detrimental to overall network throughput. The midpoint signal strength is fairly high in all three cases (−30 dBm for AP 6, −35 dBm for AP 5 and −45 dBm for AP 9), making the likelihood of mutual interference high. The probability of packet collisions (or mutual interference) is approximately 2.3% with AP 6 or AP 5 (0.025=0.25×0.09), and approximately 2.0% with AP 5 (0.02=0.22×0.09). It can also be observed that the fringe coverage signal margin for AP 8 is 0 dB (−80 dBm vs. a minimum RSSI of −80 dBm), 5 dB for AP 6 (−75 dBm vs. a minimum RSSI of −80 dBm), 10 dB for AP 5 (−70 dBm vs. a minimum RSSI of −80 dBm), and 20 dB for AP 9 (−60 dBm vs. a minimum RSSI of −80 dBm). In this case channel 3 is assigned to AP 8 to minimize the predicted mutual interference, accounting for the fact that the transmitter signal power of AP 9 can be significantly reduced (up to 20 dB) without affecting network coverage. In some cases, a lower data rate could be assigned to the low peak throughput (0.09) access point AP 8. In this simplified example, this option is not available. In some embodiments, reports can be provided highlighting this conflict and possibly indicating whether AP 8 is needed at all, or if the combined coverage areas of AP 5, AP 6, and AP 9 would be adequate.

FIG. 6B illustrates that the region of the network with channel assignments computed by the wireless network management server 10 has been grown around the initial access point 14 choice (AP 6). The access points in this region are shown with bold circles, containing the channel assignments, and with the lines connecting the access points in the region also shown in bold. Once these channel assignments have been computed, the server determines the access points neighboring this initial region (AP 1, AP 2, and AP 1) in this example. These access points are assigned in inverse order of the number of constraints. If any of these access points had other near neighbors (which they do not in this example), assignments for these neighbors, would be made in inverted order of the number of constraints as well. In effect, this approach grows the region with assigned channels from the inside out, starting with the most constrained access points.

Of the three access points 14 (AP 1, AP 2, and AP 11) bordering the region with assigned channels, AP 2 has the most constraints (4) and with one constraint being with the unmanaged access point AP A. Given the constraints (AP A using channel 3, AP 3 using channel 3 and AP 5 using channel 2) the wireless network management server 10 assigns channel 1, the only free channel.

The assignment of a channel to AP 1, the next most constrained access point 14, presents a difficult problem. All channels have been assigned to near neighbors (AP 2 has just been assigned channel 1, AP 3 is assigned channel 3 and AP 4 is assigned channel 2). Given the constraints imposed by near neighbors of the access points neighboring AP 1, reassigning another channel to any of these access points is not a preferred option. In cases, where orthogonal signal codes can be assigned, or overlapping channels can be assigned, either one or both of these alternatives could be applied. In this simplified example these options are not available. The probability of packet collisions with the near neighbors are approximately 2.7% (0.027=0.18×0.15) with AP 2 and AP3, and approximately 1.5% (0.015=0.10×0.15) with AP 4. While AP 4 exhibits the lowest probability of mutual interference it has the highest midpoint RSSI (−40 dBm) as opposed to AP 3 (−50 dBm) and AP 2 (−60 dBm). The fringe coverage signal margin for AP 1 and AP 4 is −5 dB (−85 dBm vs. a minimum RSSI of −80 dBm), for AP 2 the margin is +5 dB (−75 dBm vs. a minimum RSSI of −80 dBm) and 15 dB for AP 3 (−65 dBm vs. a minimum RSSI of −80 dBm). In this case the least mutual interference is predicted when the wireless network management server 10 assigns channel 2 to AP 1. This decision is primarily a result of the lower probability of packet collision (1.5% vs. 2.7%). In some cases, a lower data rate could be assigned to the low peak throughput (0.09) access point AP 8. In this simplified example, this option is not available.

Finally, the wireless network management server 10 makes a channel assignment to the access point 14 AP 11. Given the constraints from near neighbor access points (AP 7 is assigned channel 3 and AP is assigned channel 2), the server assigns channel 1 for AP 11.

The channel assignments are shown in Table 2 below.

TABLE 2

| Access | Number of | Peak | Signal at | Channel | Power |
|---|---|---|---|---|---|
| Point | Constraints | Throughput | Fringe | Assignment | Setting |
| AP 6 | 0 | 0.25 | −75 dBm | 1 | — |
| AP 5 | 0 | 0.22 | −70 dBm | 2 | — |
| AP 3 | 0 | 0.18 | −65 dBm | 3 | — |
| AP 10 | 0 | 0.18 | −80 dBm | 2 | — |
| AP 7 | 0 | 0.15 | −70 dBm | 3 | — |
| AP 4 | 1 | 0.10 | −85 dBm | 2 | — |
| AP 9 | 1 | 0.25 | −60 dBm | 3 | — |
| AP 8 | 1 | 0.09 | −80 dBm | 2 | — |
| AP 2 | 0 | 0.18 | −75 DBm | 1 | — |
| AP 1 | 1 | 0.15 | −85 dBm | 1 | — |
| AP 11 | 0 | 0.05 | −50 dBm | 1 | — |

Table 2 shows the number of constraints imposed on each access point 14 by channel assignment conflicts with near neighbors. In this example, these constraints are determined by counting the number of near neighbors using the same channel. In other embodiments, next nearest neighbors (or deeper neighbor relationships) are considered as well. In yet other embodiments, the constraints may be determined from the number of neighbors with overlapping coverage areas 18, and typically determined by predicted signal strength values.

The wireless network management server 10 can set the transmission power of the access points 14 with no constraints to the maximum allowed of +100 dBm. This setting can be used for all access points except AP. It will be noted that a −5 dB margin for access points 14 AP 1 and AP 4 (−85 dBm vs. a minimum desired RSSI of −80 dBm at the fringe of the coverage area) means that even at the maximum transmission power of +100 dBm the signal margin desired cannot be achieved. In some embodiments, the wireless network management server can generate reports indicating this difficulty and perhaps suggesting the moving of existing access points and/or installation of additional access points. In some embodiments, these reports can include predictions of mutual interference and coverage area. For example, the reports can indicate placement and settings for additional access points that can both improve coverage and reduce mutual interference.

The wireless network management server 10 now determines the power settings for the two constrained pairs of access points 14, AP 1 and AP 4 and AP 8 and AP 9. These access point pairs and the lines joining them are shown in bold in FIG. 6C. As already discussed, the low signal margin (−5 dB) at the fringes of the network require the power settings of both AP 1 and AP 4 to remain at the maximum of +100 dBm. The server then computes power settings for AP 8 and AP 9. The transmission power of AP 8 is set to 100 dBm, giving a 0 dB margin with respect to the desired minimum signal strength of −80 dBm at the fringes of the coverage area. The transmission power for AP 9 can be set to −70 dBm and still maintain the minimum desired signal strength of −80 dBm at the fringes of the coverage area. This reduced power setting should reduce the expected mutual interference between AP 8 and AP9.

The final channel and power assignments are shown in Table 3. In some embodiments, these settings are transmitted from the wireless network management server 10 through the wired network 20 to the access points 14, possibly using SNMP protocols.

TABLE 3

| | Number of | | | | |
|---|---|---|---|---|---|
| Access | Con- | Peak | Signal at | Channel | Power |
| Point | straints | Throughput | Margin | Assignment | Setting |
| AP 6 | 0 | 0.25 | −75 dBm | 1 | 100 dBm |
| AP 5 | 0 | 0.22 | −70 dBm | 2 | 100 dBm |
| AP 3 | 0 | 0.18 | −65 dBm | 3 | 100 dBm |
| AP 10 | 0 | 0.18 | −80 dBm | 2 | 100 dBm |
| AP 7 | 0 | 0.15 | −70 dBm | 3 | 100 dBm |
| AP 4 | 1 | 0.10 | −85 dBm | 2 | 100 dBm |
| AP 9 | 1 | 0.25 | −60 dBm | 3 | 70 dBm |
| AP 8 | 1 | 0.09 | −80 dBm | 2 | 100 dBm |
| AP 2 | 0 | 0.18 | −75 DBm | 1 | 100 dBm |
| AP 1 | 1 | 0.15 | −85 dBm | 1 | 100 dBm |
| AP 11 | 0 | 0.05 | −50 dBm | 1 | 100 dBm |

Overview of Solution Methods

Those skilled in the art will recognize that in most real-world cases, computing an exact solution to Equation 2 will be impractical if not impossible. Those skilled in the art will also recognize that a large number of suitable estimation, machine learning and optimization techniques can be applied to compute approximate solutions for Equation 2. Generally, suitable solutions will exhibit at least the following attributes:
1. The computational method should determine a good solution, avoiding mathematically “local optimum”, which do not represent a good overall solution, or avoiding degenerate solution exhibiting undesirable properties;
2. The solution method should be computationally efficient so that each step of iteration can be accomplished in a reasonable amount of time;
3. The solution method should converge as rapidly as is practical, and not require a large amount of time or large number of iterations to find a desirable solution; and,
4. The solution method should produce a stable solution or a solution that does not exhibit significant discontinuities or oscillate about a desired solution as the computation proceeds.
   Possible Solution Algorithm

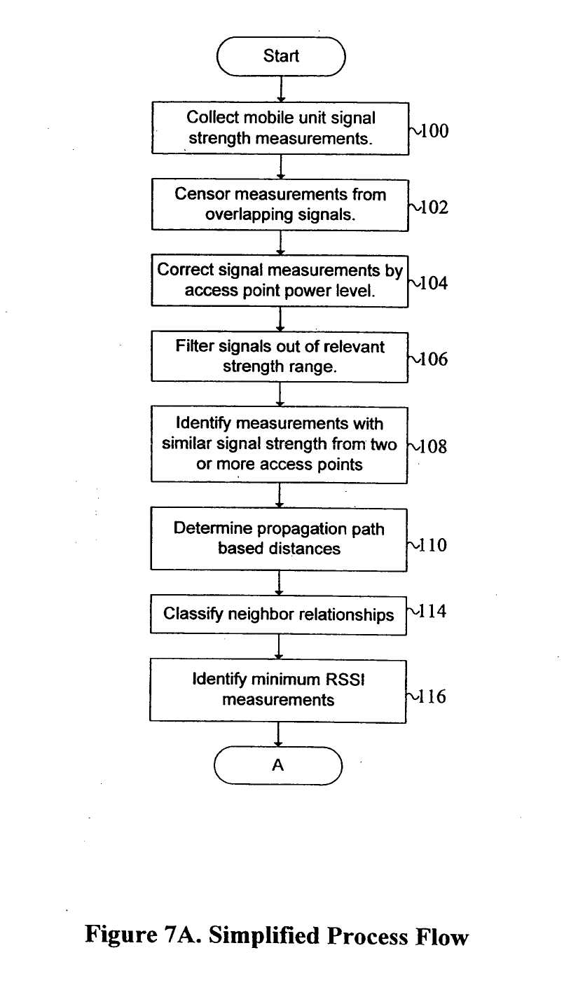

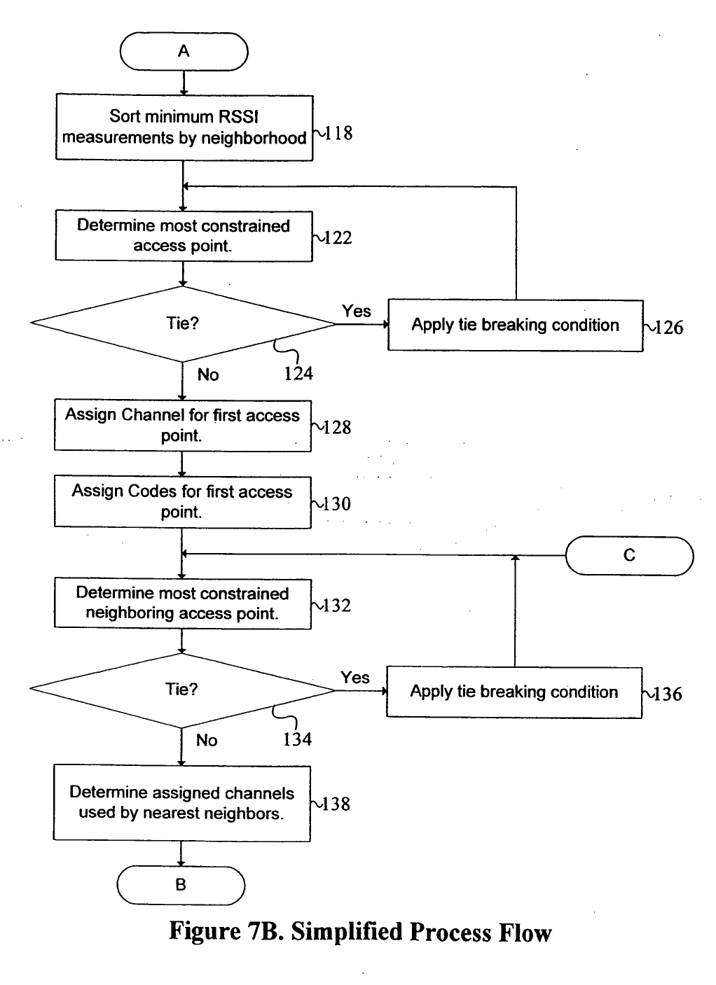

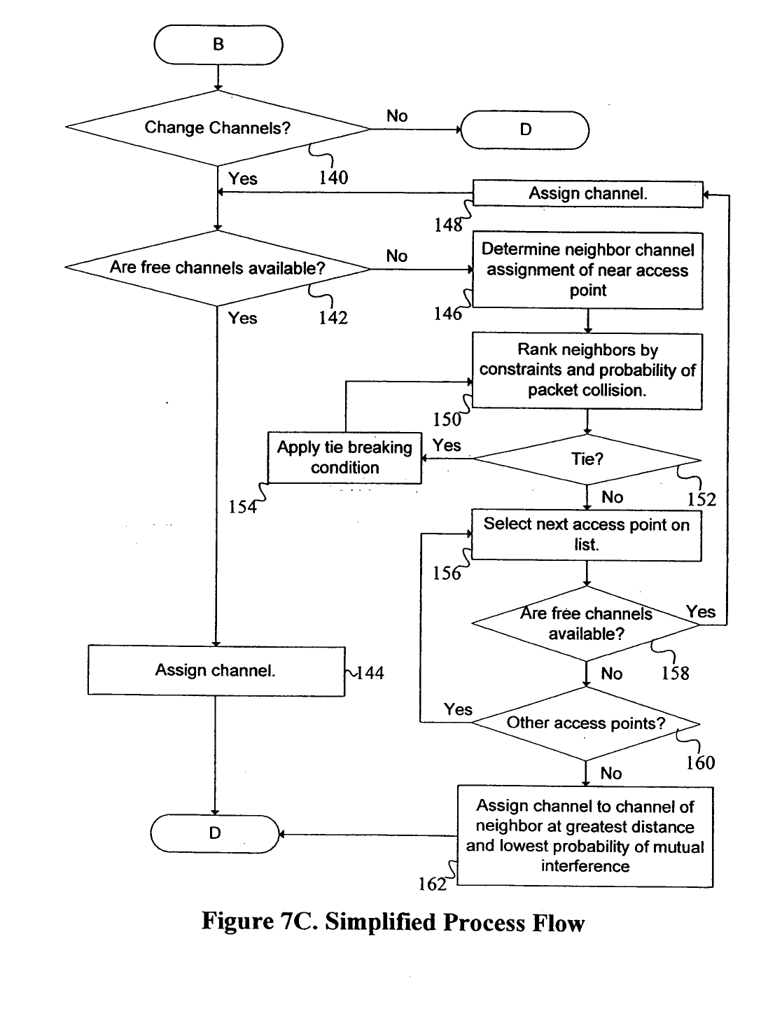

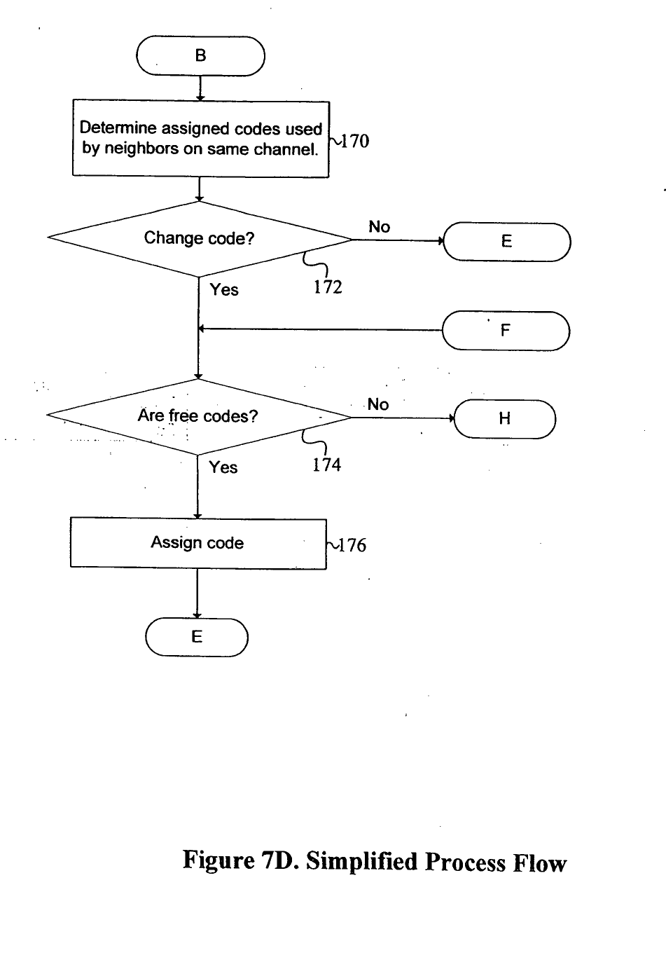

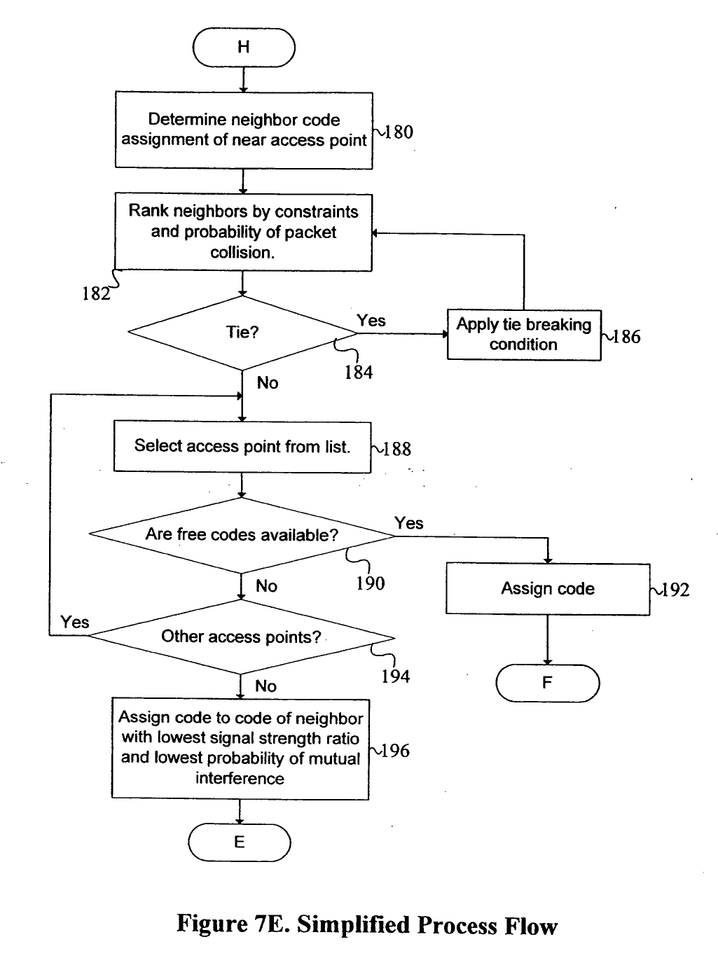

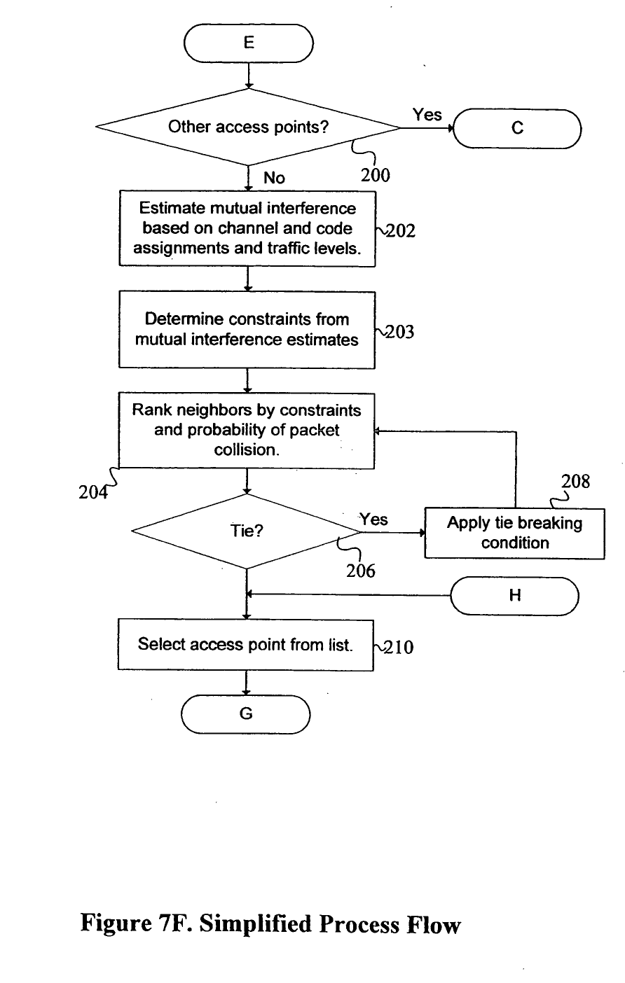

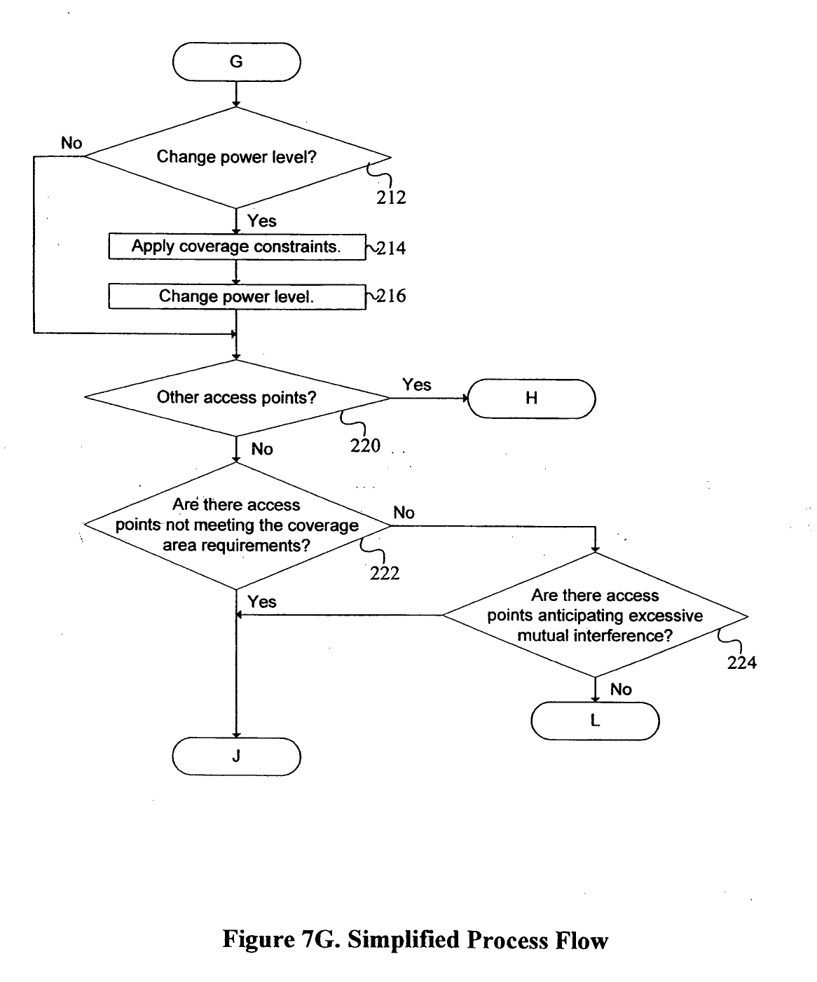

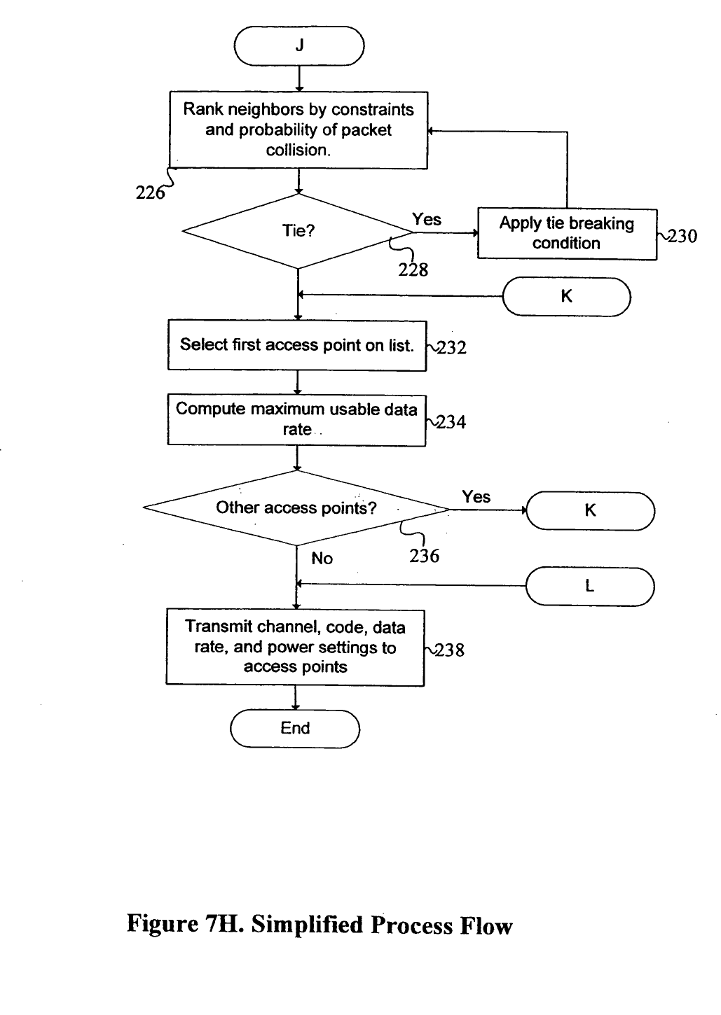

One possible solution algorithm for solving Equation 2 is shown in FIG. 7A, 7B, 7C, 7D, 7E, 7F, 7G and 7H. This algorithm separates the determination of channel, signal coding, power, and transmission data rate settings into separate steps. In some embodiments, the algorithm runs on the wireless network management server 10 and uses the data in the AP signal files 12. Clearly, other algorithms, including those, which consider these variables simultaneously, could be used and may have advantages in some situations. Thus, the algorithm discussed is only one example of many suitable algorithms possible. It will also be noted that, depending on the situation and the degree of accuracy of the solution desired the algorithm discussed could be simplified by eliminating steps. In many cases, the order of steps shown can be changed to better fit the situation or, at times, with no affect at all.

The wireless network management server 10 collects 100 the access point 14 signal strength information received from the mobile units 16 and stores this information in the AP signal files 12. Signal measurements from overlapping signals (i.e. signal measurements made from colliding packets) are censored 102 from the data set. The server then computes and applies power corrections to the signal measurements 104. In some embodiments, the wireless network management server polls SNMP MIBs on the access points to determine the power levels being used. Any suitable power correction can be applied. Examples of factors to be considered in determining the correction to use include:
1. use of a linear power correction or a power law based on an exponent determined heuristically, to account for the access point 14 transmitted power level;
2. applying correction factors for the antennas used by the mobile unit 16 and the access point 14;
3. applying a correction factor for the antenna used by the mobile unit, and,
4. applying a correction factor for the characteristics of the receiver of the mobile unit 16 making the signal measurements.

The wireless network management server 10 then filters of censors 106 the access point 14 signal strength measurements reported by the mobile units 16. Signal strength measurements out of the desired range are filtered or censored out before they are used to compute access point neighbor relations. Lower RSSI measurements are retained to determine network coverage area 18, or identify coverage problems. Criteria for filtering or editing signal strength measurements can include:
1. high signal strength measurements may be censored from the data set, since they may represent measurements made close to an access point 14 (possibly in the near field) or are at the upper limit of the mobile unit's 16 signal strength measurement range and thus may be inaccurate; and,
2. signals with a low measurement value may be censored from the data set since these measurements are too weak to be significant to the management of the wireless network or may be too susceptible to noise.

Once the filtering steps 106 have been completed, the wireless network management server 10 can group one or more access point 14 signal strength measurements in a preprocessing step 108. The goal is to find the most representative set of values of the measurements made by the mobile units 16. As an example, combing measurements can improve the accuracy (reduce variance or dispersion) inherent in these measurements. The dispersion in signal strength measurements can arise from a number of sources including, the irregular travel paths of the mobile units, mutipath signal propagation, changes in antenna polarization of the mobile unit, and the presence of natural or artificial noise sources. A number of suitable grouping steps could be applied, singly or in combination, including possibly one or more of the following:
1. grouping mobile unit 16 signal strength measurements or signal strength ratios from similar (e.g., N closest) signal strength levels for signal strength ratios (between pairs of access points) that are closest to unit (0 dB);
2. grouping mobile unit 16 signal strength measurements (between pairs of access points) for a range of signal strength ratios close to unity (e.g., a 10 dB range);
3. the use of probabilistic, rule-based or fuzzy set measures to determine if the mobile unit 16 signal strength measurements are a member of the group or class representative of the propagation conditions, and to which other estimators may then be applied; and,
4. use of adaptive or evolutionary estimation models (genetic algorithms, simulated annealing, clustering algorithms, and non-parametric regression) to the mobile unit 16 signal strength measurements representative of the propagation conditions.

In step 110, the wireless network management server 10 determines RSSI, the values used to measure distance between the access point 14 pairs, based on mobile unit 16 measurements. The goal of these computations can be to determine the point at which signals from each pair of access points are a maximum, but with a ratio of unity (0 dB) or nearly unity. As has been previously discussed, signal measurements at these points can be representative of the midpoint of the propagation path and can be representative of the distance between pairs of access points. A number of techniques can be applied including,
1. Scaning the AP signal files 12 to find the mobile unit 16 RSSI measurements where the ratio between the RSSI for two or more access points 14 is within some range of unity and determining a mean or median value;
2. Using a statistical or fuzzy estimator to find the inflection points in a curve of the ratio of the signal strength for two or more access points 14, and collected as the mobile unit 16 travels; for example the curves can be estimated using splines, polynomials, or piecewise linear models, and the estimated curve used to compute the inflection point (if any); and, Using moving filters or smoothers to determine breakpoints or inflections in the signal strength curves as a function of time for the moving mobile units 16, and using time as a surrogate for distance.

Once suitable measurement values have been determined, the wireless network management server 10 can scan the preprocessed AP signal files 12 to determine the neighbor relationships 114 between the access points 14. In some embodiments, one or more threshold are used to classify the neighbor relationships. For example, neighboring access points with high relative signal strength (at the point near where they are equal) can be considered near neighbors, while those with lower signal strength can be considered far neighbors. In another example, the continuum of signal strength values can be divided into any number of arbitrary categories (near, medium, far, etc.). It should be noted that in these embodiments, neighbor relations are based on signal propagation characteristics rather than measurements of geographic distance. In alternative embodiments, geographic distance data can be used. In yet other alternative embodiments, geographic distance data combined with signal strength data can be used.

In step 116 the wireless network management server 10 determines the lowest RSSI measurements for each access point's 14 coverage area 18. This process is intended to find the RSSI experienced by the mobile units 16 at the fringes of the network's coverage area. These measurements can be restricted to those made for the access point the mobile unit is currently associated with. This approach assumes that mobile units associate with the access point with the best signal strength in a given location. One or more measurements may be combined to improve the accuracy (reduce variance or dispersion) inherent in these measurements. The dispersion in signal strength measurements can arise from a number of sources including, the irregular travel paths of the mobile units, multipath signal propagation, changes in antenna polarization of the mobile unit, and the presence of natural or artificial noise sources. A variety of techniques can be applied to determining fringe coverage RSSI levels including:
1. computing a mean or median of mobile unit 16 signal strength measurements similar (i.e., N lowest) signal strength levels;
2. computing a mean or median of mobile unit 16 signal strength measurements within a range of signal strength ratios (i.e., 10 dB range) near a minimum;
3. the use of probabilistic, rule-based or fuzzy set measures to determine if the mobile unit 16 signal strength measurements are a member of the group or class representative of the propagation conditions, and to which other estimators may then be applied; and,
4. use of adaptive or evolutionary estimation models (genetic algorithms, simulated annealing, clustering algorithms, and non-parametric regression) to the mobile unit 16 signal strength measurements representative of the propagation conditions.

In step 118, the wireless network management server 10 then searches the AP signal files to find RSSI measurements from other access points 14 made near the time the mobile unit 16 experienced minimum RSSI for the access point it is associated with. This procedure is used to identify other access points with which the mobile unit could have associated with, and to characterize the propagation conditions with respect to these alternatives. Once these measurements have been identified they can be combined using techniques, such as those described for the previous step, to compute a single, representative, measurement for each alternative access point. Once computed, these alternative relationships and the signal propagation information can be used to create reports used to improve network coverage. Examples of these reports have already been presented.

The wireless network management server 10 can now begin the assignment of channels, signals codes and power levels for the access points 14. The process typically begins with determining the most constrained access point 122 as the starting point for the assignment process. An access point constraint is some condition that may limit the freedom to select the settings for an access point. A number of techniques can be used to determine the constraints for an access point including,
1. counting the number of near neighbors of the access point;
2. the probability of packet collisions between each access point and its neighbors;
3. using a count of the number of near neighbors weighted by a function of the probability of packet collisions between each access point and its neighbors;
4. using a count of the number of near neighbors weighted by a function of signal strength;
5. a measure of critical coverage areas 18 for that access point which may be combined with counts (or weighted counts) of the number of near neighbors; and,
6. counting the number of near neighbors (or weighted count) and applying a factor based on the number of next nearest (or other high-order neighbor relationship), and possibly using a measure of critical coverage areas 18 for that access point.
7. Constraints imposed on the solution by a system administrator.

If one or more access points 14 exhibit the same level of constraint a tie occurs 124. This tie can be broken 126 in a number of ways including,
1. the access point with the highest signal strength with respect to one neighbor at the point at which the signal strength ratios are close to unity;
2. the probability of packet collisions between each access point and its neighbors;
3. the access point with the greatest number of next nearest neighbors; and,
4. for access points with no neighbors (isolated access points), the order can be chosen arbitrarily.

Once the most constrained access point 14 has been determined 112, the channel 128 and code 130 for that access point are assigned.

Once the channel and code is assigned for the first access point 14 has been assigned, the next most constrained neighboring access point (to one of the access points already given assignments) is selected 132 from the list. If there are no neighboring access points without assignments the next most constrained access point on the list is selected (presumably in a new group of access points or an isolated access point). The criteria used to determine the degree of constraints for the access points can be the same as has already been described. In the case of a tie in the constraint criteria 134, the tie can be broken 136 using the same conditions as have already been described.

For the access point 14 under consideration, the wireless network management server 10 determines the channels already assigned 138 to neighboring access points. In some cases there may not be any near neighbors with channels already assigned. This situation can occur where the access points are grouped in several clusters (say in buildings on a campus) and the access point is the first in the cluster to be considered, for example.

The wireless network management server 10 then determines if a channel change 140 is required for the access point 14. No channel change would be required if the access point is already using a channel not occupied by a near neighbor access point, for example. As another example, the access point may be the first in a relatively isolated cluster to be considered and thus has no near neighbors with assigned channels.

If the wireless network management server 10 determines that a channel change 140 is required for the access point 14 under consideration, the server determines if a free channel is available 142. If a free channel, or channel not being used by near neighbors, is available, the free channel is assigned 144 to the access point.

If the wireless network management server 10 determines that no free channel is available 142, the server determines 146 the assigned channels of the near neighboring access points 14 to the access points which are neighbors to the access point under consideration. In other words, the search for channel assignments is now expanded from nearest neighbors to next nearest neighbor. In other embodiments, a greater number of neighbor relationships (greater “depth”) can be considered.

The wireless network management server 10 can rank 150 the neighbors of the access point 14 under consideration using the constraints on the access point and possibly weighted the probability of packet collisions. Some techniques used to determine the constraints on the access points have been previously discussed. If there is a constraint tie 152, the tie is broken 154. Some techniques for breaking ties have already been discussed.

The wireless network management server 10 selects the next access point 14 on the ranked list 156. The server then determines if there are free channels 158 (with respect to the near neighbors of that access point). If so, a channel assignment is made 148, and the server now returns to the original access point to determine if free channels are available 142.

If the wireless network management server 10 determines that no free channels are available 158 for the neighbor access points 14, the server determines if there are other access points on the ranked list 160. If so, the server selects the next access point from the list 156 and repeats the process already described.

If the wireless network management server 10 determines there are no other near neighbor access points 14 on the rank list 160, it will assign a channel, to the original access point 162, likely to cause the least mutual interference. Determining the likelihood of mutual interference can be based on any suitable metric including, the access point neighbor with the highest signal strength (nearest neighbor), possibly weighted by the probability of packet collision. Alternatively, the probability of packet collision can be used, possibly weighted by signal strength.

Once a channel assignment has been made, the wireless network management server 10 determines the signal coding (if adjustable) for the access point 14. First, the server determines 170 the signal coding assignments of the nearest neighbors using the same channel or over lapping channels (channels where the occupied frequency bands overlap).

This determination may use nearest neighbor relationships or may search further (greater “depth”) to find near neighbors (but perhaps not only nearest neighbors) using the same channel. The server then determines 172 if a change in signal coding is required. No signal coding change is required if the access point is already using a code not occupied by a near neighbor access point, for example. As another example, the access point may be the first in a relatively isolated cluster to be considered and thus has no near neighbors with assigned signal coding. If the server determines that a signal coding change is required 172, the server determines if there are free codes available 147. If so a free code, or code not being used by near neighbors, is assigned 176 to the access point 14.

If the wireless network management server 10 determines that no free signal code is available 174, the server determines 180 the assigned signal codes of the near neighbor access points 14 to the access points which are neighbors of the access point under consideration. In other words, the search for signal code assignments is now expanded from nearest neighbors to next nearest neighbor. In other embodiments, a greater number of neighbor relationships (greater “depth”) could be considered.

The wireless network management server 10 can rank 182 the neighbors of the access point 14 under consideration using the constraints on the access point and possibly weighted the probability of packet collisions. Some techniques used to determine the constraints on the access points have been previously discussed. If there is a constraint tie 184, the tie is broken 186. Some techniques for breaking ties have already been discussed.

The wireless network management server 10 selects the next access point on the ranked list 188. The server then determines if there are free signal codes 190 (with respect to the near neighbors, using the same channel, of that access point). If so, a signal code assignment is made 192, and the server now returns to the original access point to determine if free signal codes are available 176.

If the wireless network management server 10 determines that no free signal codes are available 190 for the neighbor access points 14, the server determines if there are other access points on the ranked list 194. If so, the server selects the next access point from the list 188 and repeats the process already described.

If the wireless network management server 10 determines there are no other near neighbor access points 14 on the rank list 194, it will assign a signal code to the original access point 160 likely to cause the least mutual interference. Determining the likelihood of mutual interference can be based on any suitable metric including, the access point neighbor with the highest signal strength (nearest neighbor), possibly weighted by the probability of packet collision. Alternatively, the probability of packet collision, possibly weighted by the signal strength, can be used.

Once the wireless network management server 10 has determined channel and signal code assignments for the access points 14, the server repeats the process if there are additional access points on the list 200. The criteria used to determine the order of selection can be similar to those already described. If not, the server begins the process of determining optimal power settings.

As the first step in determining the optimal power settings, the wireless network management server 10 estimates the relative expected level of mutual interference 202 between the access points 14 given the channel and signal code assignments and mobile unit 16 measurement data in the AP signal files 12. A number of suitable techniques can be used to estimate the expected mutual interference. Factors that could be included in this estimation include:
1. counting the number of near neighbors using the same, or overlapping, channels or signal codes;
2. the peak average rate of packet transmission or some other measure of the probability of a packet collision for the access point 14;
3. the use of the same channel or channels occupying overlapping frequency bands by the access points 14;
4. the use of the same signal codes by the access points 14; and,
5. the distance between the access points in terms of signal propagation (i.e. RSSI level at the midpoint).

The wireless network management server 10 determines 203 the number of constraints on each access point 14, based on the estimates of mutual interference. These constraints are intended to estimate the relative sensitivity of mutual interference to power settings. The wireless network management server can then rank 204 the neighbors of the access point under consideration using the constraints on the access point and possibly weighted the probability of packet collisions. The same techniques, already discussed, can be used to determine the constraints on the access points, but need only consider access points using the same or overlapping frequency bands (channels). Weights can be applied to account for access points using differing orthogonal signal coding. If there is a constraint tie 206, the tie is broken 208. Some techniques for breaking ties have already been discussed. In some alternative embodiments, the access points can be listed in the inverse order of the constraints (least constrained first). In some other alternative embodiments, the ranking can be based of the degree of predicted mutual interference created by each access point and coverage area problems for each access point.
1. Once the wireless network management server 10 selects an access point 14 from the list 210. Based on the predicted interference levels, the server can determine if a change of transmission power level is required 212 for that access point. Power levels may be changed in cases where: the current power level is predicted to create excessive mutual interference and can be lowered to a level predicted to create acceptable mutual interference:
2. the mutual interference from unmanaged access points is at unacceptable levels and the power level can be increased to overcome this mutual interference;
3. the current power level is insufficient for the required coverage area, and minimal mutual interference is predicted, and the power level can be increased; and,
4. an unconstrained access point is not using the maximum allowed power.

If a power level change is required, the wireless network management server 10 may apply coverage constraints 212. Coverage constraints arise from the trade-off between coverage area 18 and mutual interference. In some embodiments, this trade-off can be expressed mathematically by the parameters λ_{1 and λ}₂ in Formula 2. The relative weight to be given coverage area and mutual interference in this trade-off can be determined by a system administrator or automatically as is described below. Alternatively, the coverage area constraint can be applied as an inequality constraint. In this alternative, the power level of potentially interfering access points are reduced until one or more constraints are met. Some examples of constraints are:
1. access point transmission power level can be reduced from the maximum until an estimated fringe coverage signal strength threshold is reached, and where the threshold is typically preset by a system administrator; and,
2. the access point transmission power level can be reduced from the maximum unit the signal strength in the overlapping (mutually interfering) coverage areas is estimated to be reduced to acceptable levels.

Once the constraints have been applied, the wireless network management server 10 sets the power level 216 for the access point 14. If there are other access points in the list 220 the process described above is repeated.

Once power levels have been set, the wireless network management server 10 can set the transmission bit rates of the access points 14. Typically, the transmission data rate will default to the highest allowed, or some other default setting. First, the server determines if there are access points not meeting coverage area requirements 222. Second, the server determines if there are anticipated problems with mutual interference within the coverage area of some access points 224. If so, the server can rank 226 the neighbors of the access point 14 under consideration using the constraints on the access point and possibly weighted the probability of packet collisions. In some embodiments, these constraints are the same as those used to determine transmission power, but need only consider access points with anticipated difficulties. Weights can be applied to account for access points using differing orthogonal signal coding. If there is a constraint tie 228, the tie is broken 230. Some techniques for breaking ties have already been discussed. In some alternative embodiments, the access points can be ranked by the predicted severity of the mutual interference or coverage area problems.

The wireless network management server 10 selects the first access point 14 from the list 232. The server computes the maximum usable data rate, given the predicted conditions 234. If there are additional access points 236 the process is repeated.

Once the wireless network management server 10 has determined the optimal channel, signal coding, transmission bit rates and power level settings, it transmits 238 these settings to the access points 14. In some embodiments, the server will use SNMP protocol messages transmitted over the network 20 to apply the desired settings using MIBs on the access points.

Alternative Solution Methods

Those skilled in the art will recognize that numerous suitable solution techniques can be applied to Equation 2 or other suitable formulations. Further, a given solution technique can attempt to find the local (with respect to neighbors) solution for access point 14 optimal channel, signal coding and power settings, a global solution or something in between. The techniques discussed above are examples of local solution techniques, since near neighbors are considered in the calculations. In other cases the neighbors of these near neighbors can be considered as well. In yet other cases, a global solution (considering all neighbor relationships) can be applied.

The example solution techniques, described above, use a step wise solution sequence, wherein, for a given access point, a channel is assigned, a signal code is assigned, transmission power is determined and transmission data rates are set for each access point.

Alternative solution techniques may attempt to compute channel, signal code, transmission data rates and power settings in one step. These computations may be local, global or something in between.

Alternative solution techniques can include a variety of evolutionary algorithms. Yet other alternatives, non-linear or even linear programming methods can be used. Combinations of solution techniques can also be applied. For example, an evolutionary algorithm can use non-linear or linear programming methods as part of the solution process.

Control of Solution

Given the trade-offs inherent in the solution of Equation 2, or any other formulation of the problem, a number of control parameters can be introduced into any practical solution method. Values of these parameters can be set by system administrators, in some cases, or automatically, in some cases. Network administrators may use the reporting capabilities of the system to evaluate the performance of the network and to determine the need to update parameter settings. Manual parameter settings are typically performed using an administrative display. In some embodiments, this display will show controls, such as slider bars, for each of the parameters to be adjusted. In other embodiments, reporting tools are used to evaluate the performance of the network based on automatically determined parameter settings. A control interface can be used to manually control parameters, possibly overriding automatic settings. Reporting capabilities have already been discussed.

Some examples of these control parameters include:

1. Parameters controlling the trade-off between network coverage and mutual interference or throughput, and which are discussed in the next section.

2. Parameters controlling the rate at which solutions are updated and updated settings are propagated to the access points 14. These parameters may require the computed solution to average data collected from the mobile units 16 over a period of time (i.e., one hour, one day, one week, one month), before settings are updated on the access points. These parameters allow the system to compute stable solutions, based on the long-term behavior of the network. If these time constants are too short, the settings may be changed in response to inconsequential changes in network measurements (i.e. variations in traffic volume), which can lead to unstable behavior or oscillations. If these parameters are set for too long of a time period, the access point settings may not change rapidly enough to respond effectively to changes in the network environment (i.e., access points being moved, foreign access points being introduced or removed from the environment, movement of physical objects in the environment). In some embodiments, parameters representing different time constants can be used. For example, parameters that determine the settings of access points covering rarely used areas (areas mobile units visit only occasionally), may use relatively long time constants. In some cases, the time constant will be infinite so that manually determined settings will not be changed. In some embodiments, a different time constant can be used for a new network or a network into which the channel, coding and power management system is newly installed; and with minimal data initially collected in either case.

3. Parameters controlling the rate of changes in access point 14 settings when a known change has been made to the network. Examples of known changes to the network include, the failure of an access point, the addition of a managed access point, the removal of a managed access point. In many of these situations the wireless network management server 10 can obtain network management information indicating a change in the condition of the network. In these situations, a faster response is often preferred, since the immediacy of the changes and the need to update access point parameters to compensate is certain. In some embodiments, parameters representing different time constants can be used. The associated time constant may be determined by the nature of the change and the data available to compute a new optimal solution or the need to collect additional data. For example, the signal data associated with the failure of a given access point may already have been collected by the mobile units 16. In some cases the setting changes may be deployed with little or no delay. As another example, signal data may need to be collected for a period of time when a new access point is installed, before making significant setting changes.

4. Parameters controlling the aging of data collected by the mobile units 16. As the network's environment changes, the signal environment experienced by the mobile units changes and therefore the signal measurements made by the mobile units at each location change. This situation can make older measurements less accurate or less representative of the present condition of the network than newer measurements. In some embodiments, older data is removed or aged from the set of measurements used for analysis on some schedule determined by control parameters. In some embodiments, a variable aging schedule can be employed. In this case a more rapid aging schedule may be employed when changes in the network environment are known to have occurred.

5. Parameters controlling the number of data samples used to compute signal strength derived quantities. In some situations the signal data measured by the mobile units 16 is highly variable even over a small range of geographic locations. In some cases, a nearly stationary mobile unit may experience fluctuations in the measured RSSI. Adding further to this measurement variability is the fact that the signal measurement properties of the mobile units themselves can be different from unit to unit. These variations can arise from a number of causes including, multi-path signal propagation, mobile unit antenna configuration, mobile unit antenna polarization, calibration and other errors in mobile unit signal measurements, and mobile unit receiver characteristics. To improve the quality of the solution given these potential variations, in some embodiments, multiple measurements can be combined before or during the computation of quantities used in the solution algorithms. In some embodiments, the algorithm used to combine these measurements can be selected. Examples of combining algorithms include, mean filters, median filters, trimming filters, time-based filters, probability based or fuzzy possibility based filters, various types of neural networks, and non-parametric filters. In some embodiments, the number of measurements combined and the time periods over which measurements can be averages are determined by user configurable parameters.

6. Parameters for controlling the range of signal strength measurements used to compute signal strength derived quantities. Mobile units have only a limited range of signal strengths they can measure (i.e. a limited dynamic range). Low signal measurements may be rendered inaccurate by noise. High signal measurements may be distorted by “near field” effects. In some embodiments, these possible problems are addressed by censoring extreme high or low signal measurements from the data set used in computations. In some embodiments, these signal thresholds may be set by type of mobile unit or even specific model of mobile unit or network interface card.

7. Parameters controlling the time constants, number of samples considered and algorithms used to determine peak access point 14 throughput. The variable nature of data network traffic or throughput and some suitable techniques to compute representative measurements have already been discussed.

Determination of Performance Trade-off Factors

The present channel, signal coding and power management system may use the trade-off between coverage and mutual interference as a constraint on the determination of optimal access point 14 settings. In some embodiments, this trade-off can be expressed mathematically by the parameters λ_{1 and λ}₂ in Equation 2. By independently setting these parameters the tradeoff between coverage and mutual interference with managed access points can be set at one level and the tradeoff between coverage and mutual interference with unmanaged access points can be set at another level. In some embodiments, these tradeoff parameters can be set on an access point by access point basis, allowing local optimization of the tradeoff.

Various suitable techniques can be used to compute the trade-off parameters. The parameters can be set at fixed values, or can be updated dynamically as additional network performance data becomes available. Collection and processing of data to measure or assess the performance of the wireless network and the trade-offs between coverage area 18 and mutual interference have already been discussed. Determination of these trade-off parameters can be performed manually by system administrators, automatically by the wireless network management server 10, set as part of a feedback process, or using some combination of manual and automated techniques.

In some embodiments, the trade-off between coverage and mutual interference can be based on time-dependent metrics. Coverage area 18 may be relatively static, whereas the paths traveled by the mobile units 16 may not be. Mobile units may not visit certain areas on a daily basis. Some areas may only be visited weekly, monthly, quarterly or at other infrequent intervals. At the same time mutual interference may be a transient event, potentially dependent on the location of mobile units and the amount of traffic presented to the network. When a network experiences high traffic volumes for a short period of time (transient peaks), there will be corresponding short periods of peak mutual interference. In some situations, network traffic flow will quickly recover from these mutual interference transients without causing undue disruption to the overall performance of the network. In other situations, high rates of sustained traffic will create sustained mutual interference and therefore sustained reduction in overall network interference. Using time-dependent metrics for determining the trade-off between coverage area and throughput can improve the performance of the network as perceived by users. In some embodiments the static parameters λ₁ and λ₂ are replaced by time dependent functions. These time dependent functions allow administrators to manually or automatically determine the trade-off in a manner that optimizes the average performance of the network rather than the transient performance. These functions can include, edge detection filters, moving average filters, median filters and predictive filters. Adjustable parameters for these algorithms can include:
1. Time constants to define transient versus steady state behavior;
2. Thresholds (or high-low limits) to define significant transients as opposed to fluctuations;
3. parameters that weight transient performance against long-term performance; and,
4. algorithms used to identify transients in traffic levels.

In some embodiments, the wireless network management server 10 or some other suitable entity will automatically determine and update any parameters controlling the trade-off between coverage and mutual interference. In some embodiments, these computations can be guided by some performance criteria, typically set by a system administrator. Examples of criteria that may be used include, the maximum expected packet retry rate from mutual interference and the degree to which the performance of the network at the edge (“fringe”) of the coverage area 18 can be improved (i.e. improved RSSI in fringe coverage areas or reduced transmission errors in fringe coverage areas). Factors that may be considered may include:
1. the fraction of the time mobile units 16 spend in poor coverage areas 18, and the nearest access points to those poor coverage area;
2. the fraction of transmitted packets requiring retransmission as a result of mutual interference between access points 14;
3. tests for transient behavior as described above, and,
4. time dependent filters used to determine if the behavior of the network has experienced a long-term change, possibly using the techniques discussed above, and which can include median filters, and edge detection filters, as described above.

In some alternative embodiments, constraints can be used for the control of the tradeoff between coverage area and mutual interference. Use of constraints to determine access point transmission power levels has been discussed previously. Typically these constraints have one or more parameters including;
3. a fringe coverage signal strength threshold, that sets the minimum desired signal strength at the edges of the network; and,
4. the minimum signal strength ratio (SNR) required to minimize mutual interference.
   Management of Redundant Access Points

In some situations a high-reliability wireless network is required. In these situations redundant access points 14 can be used. If the redundant access points are maintained in an on-line state, the result can be increased mutual interference and reduced network throughput as a result of having multiple access points with redundant coverage areas 18 using a limited set of channels and orthogonal signal codes.

To overcome these difficulties, but still allow for redundancy and high-availability, some embodiments of the power, channel and code management system include the capabilities to manage redundant access points 14 in an offline configuration and only bring them online when required. This process allows for the deployment of redundant access points, while limiting the potential for mutual interference. In some embodiments, system administrators can designate which access points are redundant. These designated redundant access points are kept in a standby mode until needed. The wireless network management server 10 can determine when an online access point has failed, typically using well-established or emerging monitoring techniques. The server then distributes optimal settings for the redundant access points, activates the redundant access points and possibly updates settings for other near-by access points. In some embodiments, SNMP protocols messages can be used to determine the state of online access points and change the settings of access points in the event of a failure.

In some embodiments, the power, channel and code management system can use data collected from the mobile units to compute power, channel, transmission data rate, and coding settings for the access points 14 in the event of a failure. In some cases, the system can periodically switch which access points are online and which are offline to allow the collection of a more complete data set, while still minimizing mutual interference. The settings for the redundant access points can be computed in advance or at the time the failure actually occurs. Techniques for computing these settings have already been addressed.

In some embodiments, the power, channel and code management system can supply system administrators with information useful in determining where redundant access points 14 should be placed. The reporting capabilities of the power, channel and code management system have already been discussed. In some cases, these redundant access points can be collocated with the online access points. In other cases, the redundant access points can be located in a pattern offset or staggered with respect to the online access points. For example, if the online access points are organized approximately in a lattice, the offline (redundant) access points can be organized in a similar but offset lattice. Similar complementary patterns may be designed for other access point deployment patterns.

Overview of Additional Examples

The following examples are presented to illustrate some of the capabilities of the channel, signal coding and power management system. These examples are intended to show possible solutions to common wireless network management problems, which the system may produce. In no case are these examples intended to indicate a limit to the scope, features or functionality of the system.

### EXAMPLE 1

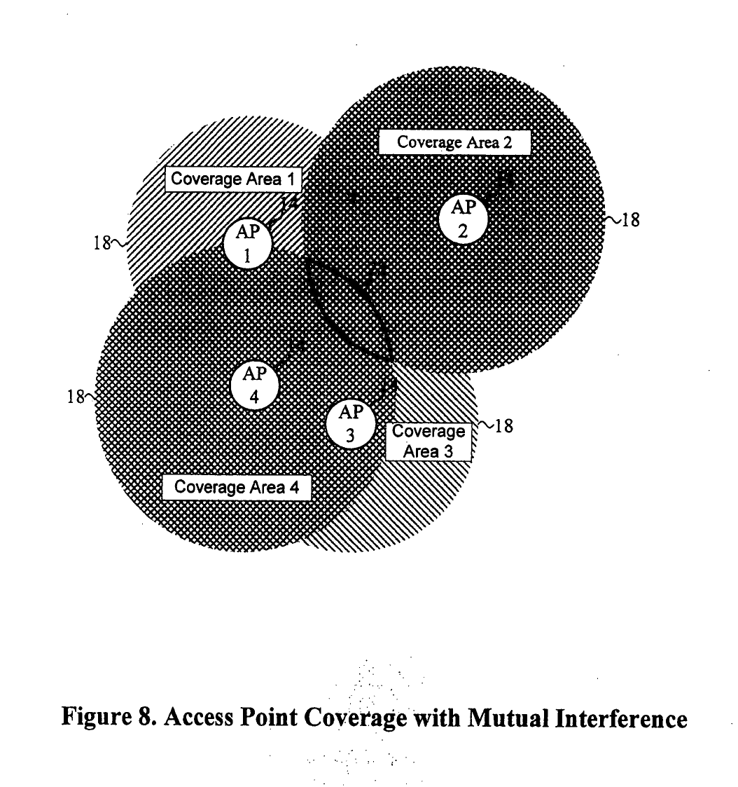

As a first example of the operation of the channel, signal coding and power management system, consider the case shown in FIG. 8. The coverage areas 18 of access points 14 AP2 and AP4 have an area of overlap 22 between coverage area 2 and coverage area 4. With both AP2 and AP4 using the same channel and signal coding, this situation is likely to create significant mutual interference.

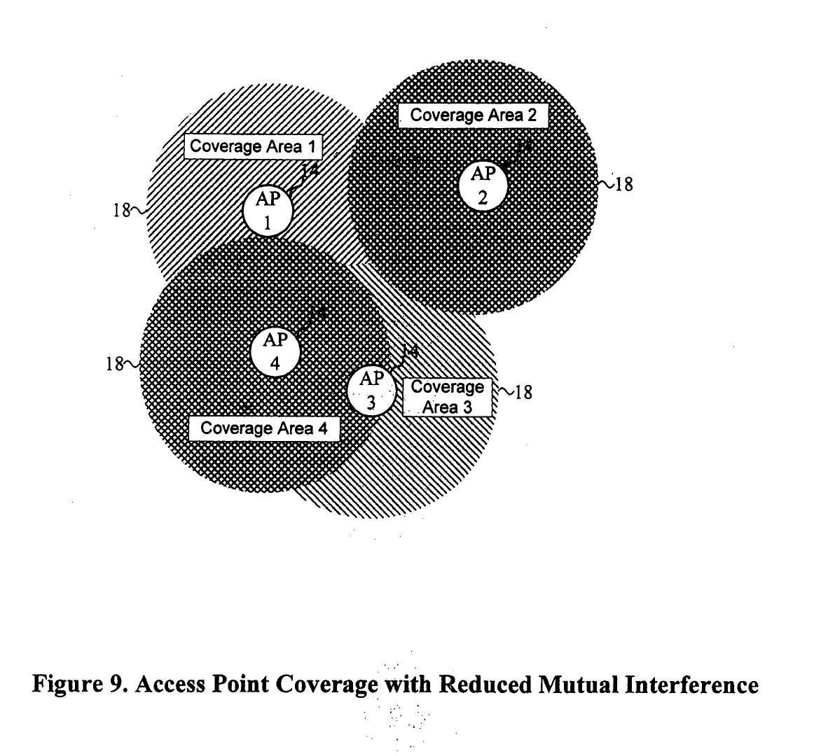

One possible solution to this mutual interference problem is shown in FIG. 9. In this case, the transmission power, and therefore the coverage areas 18, of the access points 14 has been reduced, and thereby reducing the area of mutual interference.

In an alternative solution, the signal coding of either access point 14 AP1 or AP2 or both could be changed. This solution has the advantage that the coverage area 18 of the access points need not be reduced. In other alternative solutions, the signal coding can be changed along with a reduction in access point power levels to reduce the mutual interference, but still retain required coverage area.

In yet another alternative solution, the transmission data rate of either or both access points 14 (AP 2 or AP 4) could be reduced to increase the robustness to the packet collisions. This alternative could be used in conjunction with other solutions.

### EXAMPLE 2

In a second example of the operation of the channel, signal coding and power management system, consider the case shown in FIG. 10. The coverage areas 18 of access points 14 AP1 and AP3 have an area of overlap 22 between coverage area 1 and coverage area 3. With both AP1 and AP3 using the same channel and signal coding, this situation is likely to create significant mutual interference.

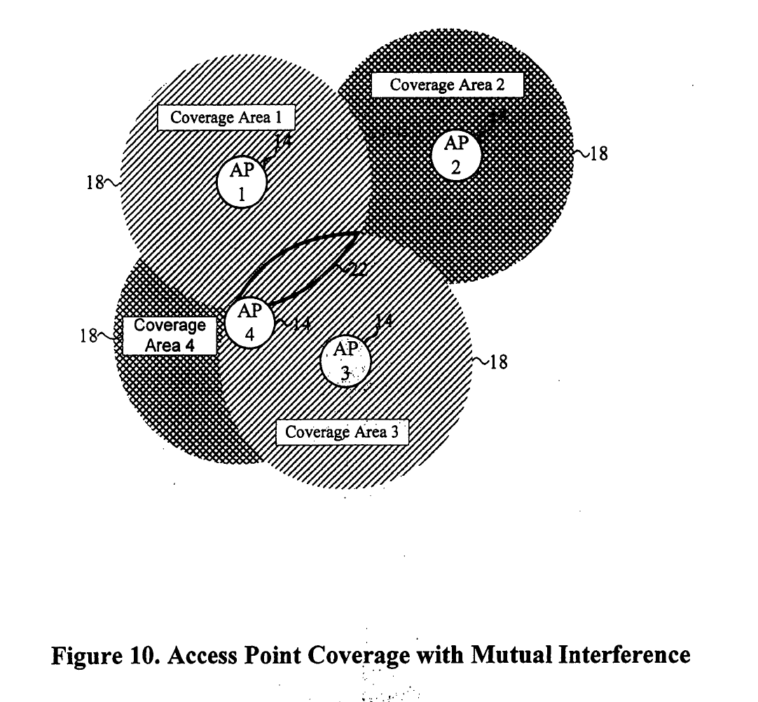

One possible solution to this problem is shown in FIG. 11. The channel used by access point 14 AP3 is changed and the area of mutual interference reduced or eliminated. In an alternative solution, the signal coding used by AP1 or AP3 or both could be changed. Either solution maintains the coverage area 18 of the wireless network.

### EXAMPLE 3

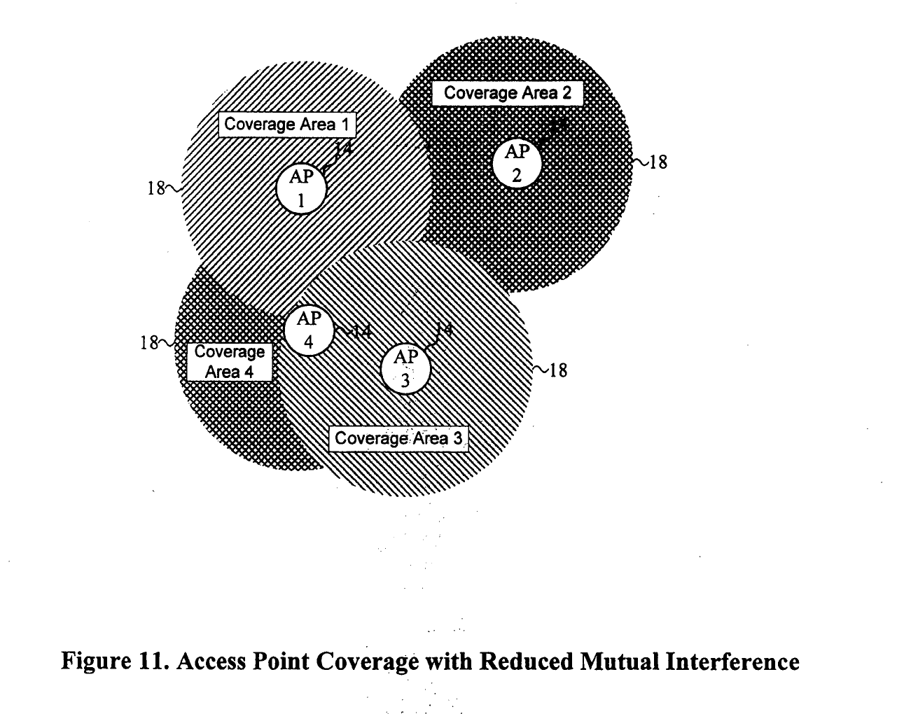

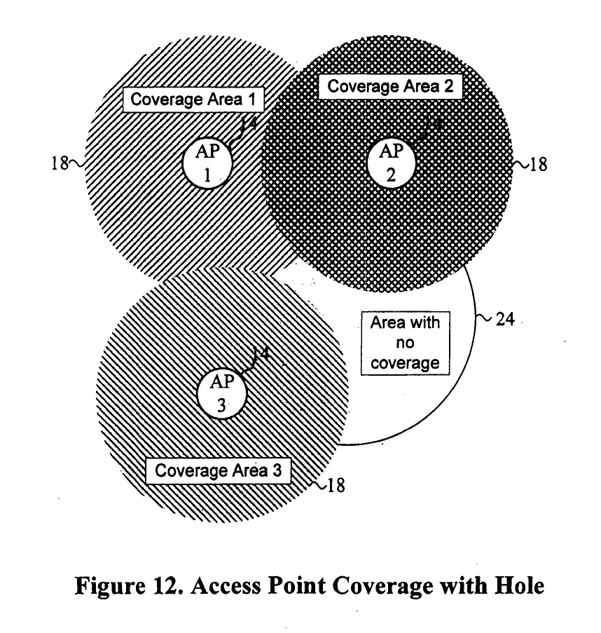

As a third example of the operation of the channel, signal coding and power management system, consider the case shown in FIG. 12. In this case the coverage area 18 of the three access points 14, AP1, AP2 and AP3, are insufficient, producing an area with no coverage 24.

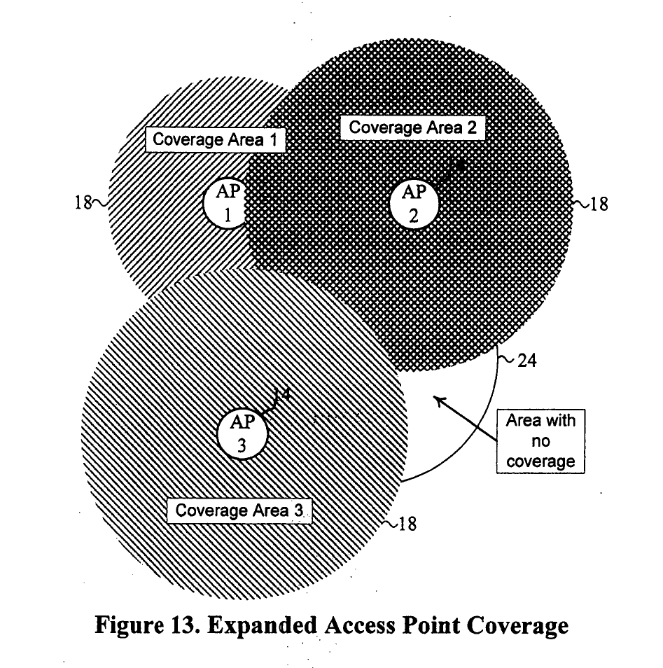

One possible solution to this problem is shown in FIG. 13. In this case, the transmission power levels, and therefore the coverage areas 18 (coverage area 2 and coverage area 3, of access points 14 AP2 and AP3) have been increased. Assuming that the three access points are using different channels and possibly codes, the solution shown does not increase mutual interference. Depending on the transmission power limits and propagation conditions an area with no coverage 24 could still remain as is shown in FIG. 13. Alternatively, the transmission data rate of either or both access points 14 (AP 2 or AP 3) could be reduced to increase the effective coverage area. Both data and transmission power can be changed together.

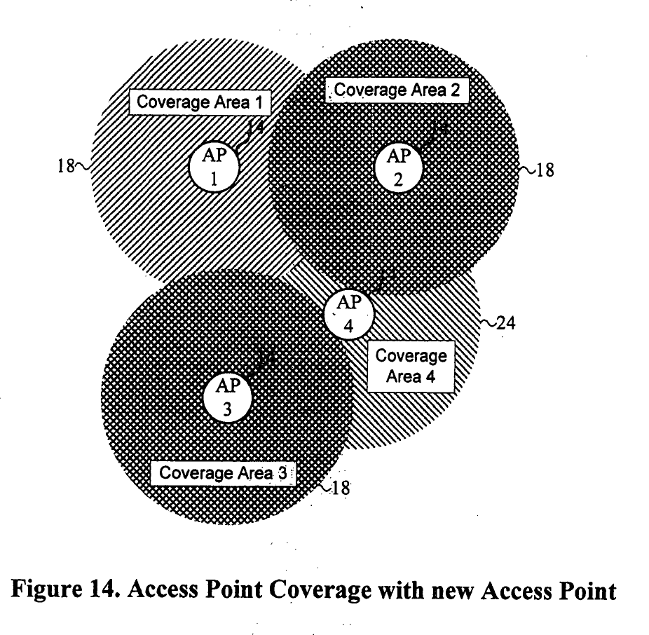

In alternative solution, an additional access point 14 can be added to the wireless network as is shown in FIG. 14. In this case, AP 4 is added to the network. Coverage area 4 effectively eliminates the area of no coverage 24. To reduce the chances of mutual interference the channel assignment of access point AP3 is changed. At the same time, the signal coding used by any of the four access points can be set to minimize potential mutual interference. In some embodiments, the decision to add the addition access point will be made by network administrators using the reports produced by the channel, signal coding and power management system. Reporting functions have been discussed above.

### EXAMPLE 4

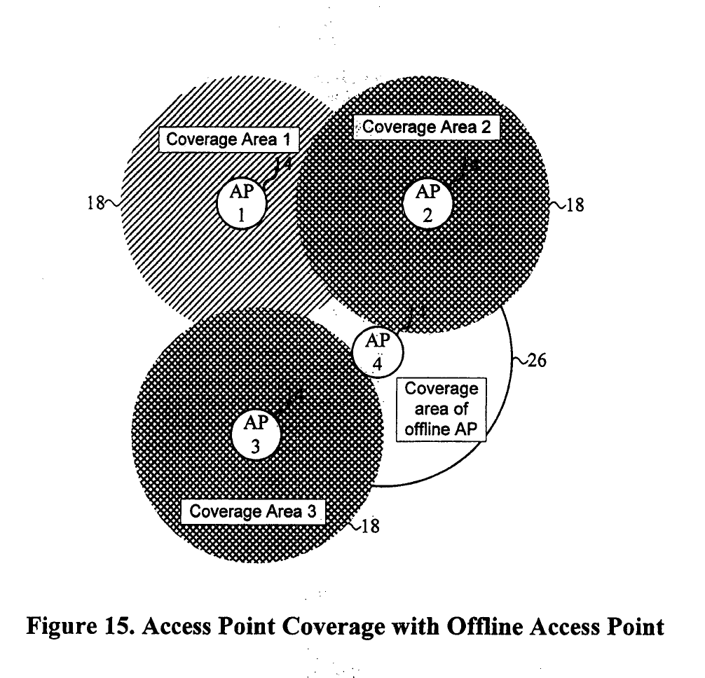

In a fourth example of the operation of the channel, signal coding and power management system, consider the case shown in FIG. 15. In this case the coverage area 18 of the wireless network has been reduced by the failure of access points 14 AP4. This failure results in disrupted network operations in the coverage area of the offline AP 26.

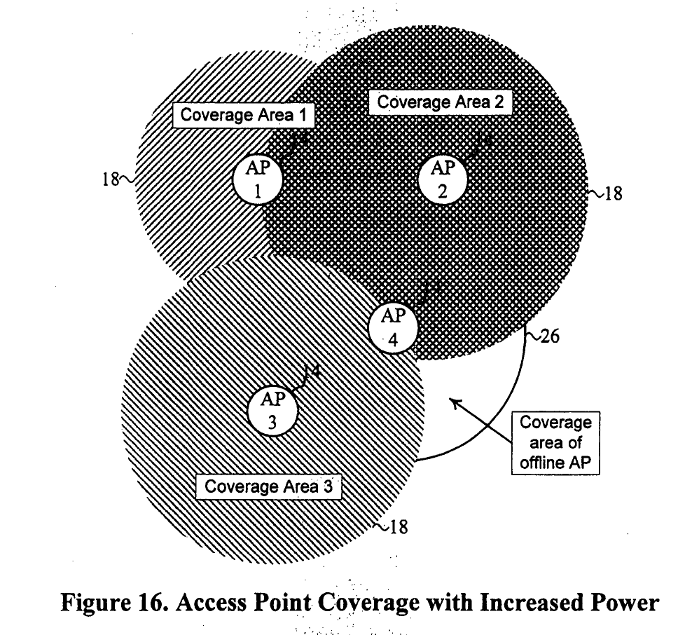

One possible solution to this problem is illustrated in FIG. 16. In this case, increasing the transmission power has increased the coverage areas 18 (coverage area 2 and coverage area 3) of the access points 14 (AP2 and AP2). At the same time, the channel assignment of AP3 is changed, possibly along with signal coding for the three access points, to prevent or reduce mutual interference. This solution reduces, but does not completely eliminate the portion of the coverage area of the offline AP 26 without network service. Alternatively, the transmission data rate of either or both access points 14 (AP 2 or AP 3) could be reduced to increase the effective coverage area. Both data and transmission power can be changed together.

### EXAMPLE 5

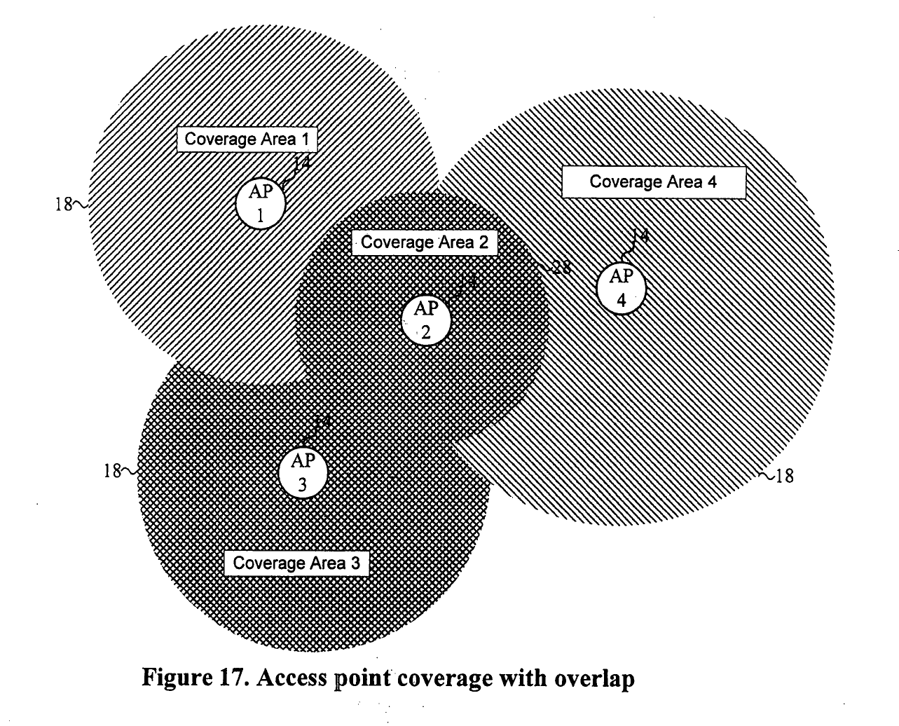

In a fifth example of the operation of the channel, signal coding and power management system, consider the case shown in FIG. 17. In this case the access point 14 AP2 has coverage area 2. This coverage area 26 overlaps with the coverage areas 18 of access points AP1, AP2, and AP4: coverage area 1, coverage area 3 and coverage area 4. Thus, AP2 does not increase or otherwise improve the overall coverage of the wireless network. Further AP2 is using the same channel and code assignments as AP3. In this case significant mutual interference between AP2 and AP3 is expected. This situation could likely lead to reduced network throughput from an increased level of packet collisions. The decrease in throughput as packet collisions increase is illustrated in FIG. 3 and has been discussed previously.

In one possible solution to the problem, the access point 14 AP2 is removed from the network. The overlapping coverage areas 18 of AP1, AP3 and AP4 (coverage area 1, coverage area 3, and coverage area 4) are sufficient to maintain the overall coverage area of the network. Further, the reduction in packet collisions will likely improve the network throughput. In some embodiments, the decision to remove an access point will be made by network administrators using the reports produced by the channel, signal coding and power management system. Reporting functions have been discussed above.

Another possible solution is to assign new signal codes to one or more of the access points 14. In this case the mutual interference between AP2 and AP3 could be reduced, if not eliminated.

### EXAMPLE 6

In some embodiments of the channel, code and power management system, redundant access points 14 can be managed. Some aspects of redundant access point management schemes have been discussed above. The channel, code and power management system can manage redundant access points that are placed on regular grids or with an irregular placement. In some cases, the redundant access points can be collected with the online access points while in other cases, the redundant access points can be placed at other locations. In some embodiments, the redundant access points are managed in an offline (not transmitting or receiving) condition until needed.

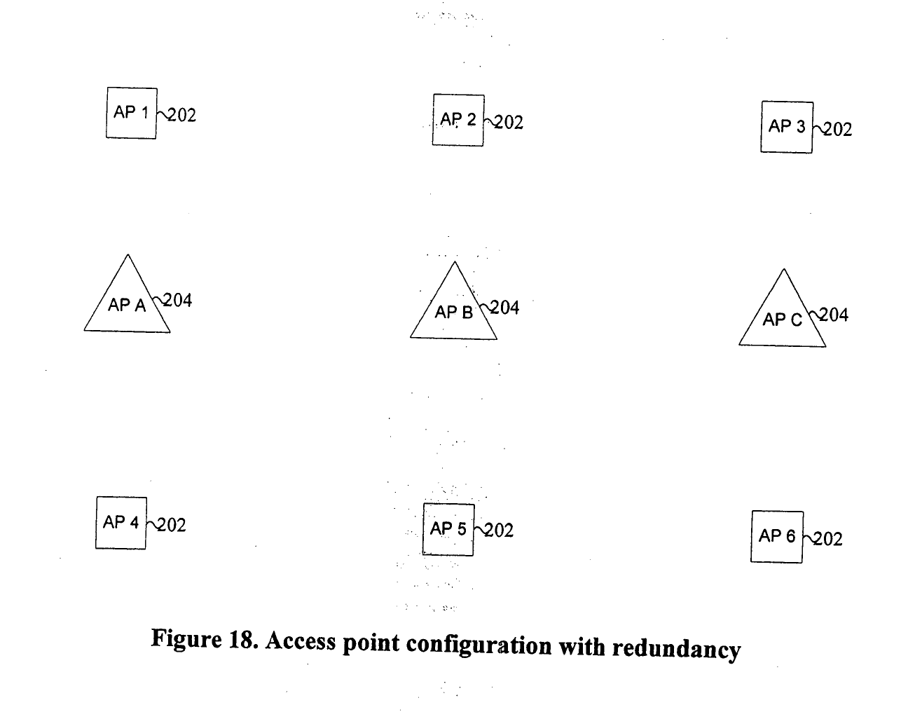

An example of a redundant access point deployment scheme is show in FIG. 18. In this example, the online access points 202 (shown by squares as AP1, AP2, AP3, AP4, AP5, and AP6) are deployed on a regular grid or lattice. The redundant access points 204 (show by triangles as AP A, AP B, and AP C) are deployed in an offset pattern. In this example the failure of one or more of the online access points can trigger the channel, code and power management system to activate one or more of the redundant or offline access points. At the same time the channel, code and power management system can change settings on the remaining access points that were previously online to optimize the performance of the network.

As a more specific example, suppose that online access point 202 AP1 fails. Once the channel, code and power management system has detected or otherwise been notified of the failure, it will activate the offline access points 204, AP A and AP B. During the activation process the settings of these redundant or offline access points are distributed and invoked. At the same time, settings for the remaining primary (online) access points can be changed to optimize the performance given the new network configuration.

1. A system for managing a wireless local area network, comprising:
one or more access points having controllable settings;
one or more mobile units adapted to communicate with the one or more access points and report signal quality information; and
a controller for processing the reported signal quality information and determining one or more settings for one or more of the access points, wherein the one or more settings being communicated to the one or more access points.

2. The system of claim 1, wherein the signal quality information comprises one or more of signal strength information, packet transmission rates, packet collision rates, packet retransmission rates, a signal to noise ratio, information derived from signals transmitted by unmanaged access points, and information derived from non-access point sources of radio frequency energy.

3. The system of claim 2, wherein the unmanaged access points comprise one or more of an access point without controllable settings, an access point belonging to a different wireless local area network, and an access point with limited range of controllable settings that make it difficult to regulate the wireless local area network.

4. The system of claim 1, wherein the controllable settings comprise one or more of a channel setting, a power setting, a coding setting, and a transmission data rate.

5. The system of claim 1, wherein the controller is adapted to determine one or more of a preferred tradeoff between coverage and interference for the wireless local area network and whether one or more redundant access points should be enabled in response to the reported signal quality information.

6. The system of claim 1, wherein the controller is adapted to determine one or more of a preferred tradeoff between coverage and interference at multiple frequencies at an access point.

7. The system of claim 5, wherein the relative importance to be given coverage and interference in determining the preferred tradeoff is set by one or more of a network administrator and the number of mobiles expected to be in an area with impaired coverage.

8. A method for managing a wireless local area network, the method comprising:
receiving from a plurality of mobile units signal quality information, wherein the mobile units are adapted to communicate with the one or more access points in the wireless local area network to collect information relating to signal quality and to report this information to a controller for the wireless local area network;
processing the reported signal quality information and determining one or more settings for one or more of the access points; and
communicating the one or more settings to the one or more access points, wherein the one or more settings comprise one or more of a channel setting, a power setting, a coding setting, and a transmission data rate.

9. The method of claim 8 further comprising one or more of enabling a redundant access point and disabling an access point as part of the settings determined from the signal quality information.

10. The method of claim 9 wherein a time constant for implementing a new setting is set to one or more of a default value to avoid oscillations or unstable behavior, shorter than the default value in response to a known change in the wireless local area network, and longer than the default value in response to variations in utilization patterns.

11. The method of claim 10, wherein the known change is one or more of a failure of an access point, the addition of a managed access point, the removal of a managed access point, and discovery of an unmanaged access point.

12. The method of claim 9 wherein a response time for implementing a new setting is shortened in response to a known change to the wireless local area network, wherein the known change comprises one or more of a failure of an access point, the addition of a managed access point, the removal of a managed access point, and discovery of an unmanaged access point.

13. The method of claim 8, wherein the signal quality information comprises one or more of signal strength information, packet transmission rates, packet collision rates, packet retransmission rates, a signal to noise ratio, information derived from signals transmitted by unmanaged access points, and information derived from non-access point sources of radio frequency energy.

14. The method of claim 8 further comprising estimating a fraction of mobile devices affected by one or more of mutual interference, low signal to noise ratio, low signal strength, and low throughput.

15. The method of claim 14 further comprising estimating new settings to reduce the fraction of estimated mobile devices affected by one or more of mutual interference, low signal to noise ratio, low signal strength, and low throughput.

16. The method of claim 8 further comprising estimating in an area of coverage a signal strength and a retransmission rate by mobile units; and inferring increased mutual interference if both the signal strength and the retransmission rate are high.

17. The method of claim 16 further comprising estimating a number of mobile units affected by the increased mutual interference; and adjusting transmission power settings of one or more access point to reduce the number of mobile units affected by the increased mutual interference.

18. The method of claim 8 further comprising detecting in an area of coverage a signal strength and a retransmission rate by mobile units; and inferring an excessive signal to noise ration if the mobile units detect only one access point having a weak signal strength resulting in a high retransmission rate; and generating a new setting with a lowered transmission data rate for the access point.

19. The method of claim 8 further comprising detecting in an area of coverage only a weak signal strength from access points resulting in a high retransmission rate by mobile units; inferring a fringe region from the low signal strength and the high retransmission rate; and generating a new power setting for at least one access point or enabling a new access point.

20. A mobile device adapted to communicate with the one or more access points and report signal quality information, comprising:
a signal quality module to scan one or more channels for an access point identifier, a value of received signal strength indicator, statistics on packet transmission rates, packet retry rates, and signal to noise ratio; and
a module to transmit buffered signal quality information in response to a query by a controller in wireless local area network.

21. The mobile device of claim 20 further comprising:
a module to generate the signal quality information based on information collected by the signal quality module.

22. The mobile device of claim 20, wherein the signal quality information comprises one or more of signal strength information, packet transmission rates, packet collision rates, packet retransmission rates, a signal to noise ratio, information derived from signals transmitted by unmanaged access points, and information derived from non-access point sources of radio frequency energy.

23. A system for managing a wireless local area network, comprising:
means for modifying controllable settings of one or more access points;
means for communicating with the one or more access points and reporting signal quality information; and
means for processing the reported signal quality information and determining one or more controllable settings for one or more of the access points, wherein the one or more settings is being communicated to the one or more access points such that the controllable settings implement one or more of a preferred tradeoff between coverage and interference for the wireless local area network and whether one or more redundant access points should be enabled in response to the reported signal quality information.

24. The system of claim 23, wherein the signal quality information comprises one or more of signal strength information, packet transmission rates, packet collision rates, packet retransmission rates, information derived from signals transmitted by unmanaged access points, signal to noise ratio, and information derived from non-access point sources of radio frequency energy, and wherein the unmanaged access points comprise one or more of an access point without controllable settings and an access point belonging to a different wireless local area network.

25. The system of claim 24, wherein the controllable settings comprise one or more of a channel setting, a power setting, a coding setting, and a data rate.
